(19) United States
(12) Patent Application Publication
(10) Pub. No.: US 2017/0045203 A1
(43) Pub. Date: Feb. 16, 2017

(54) CONFIGURABLE LIGHTING DEVICE USING A LIGHT SOURCE AND OPTICAL MODULATOR

(71) Applicant: ABL IP Holding LLC, Conyers, GA (US)

(72) Inventors: An MAO, Reston, VA (US); Ravi Kumar KOMANDURI, Dulles, VA (US); Rashmi Kumar RAJ, Herndon, VA (US); David P. RAMER, Reston, VA (US)

(21) Appl. No.: 15/234,031

(22) Filed: Aug. 11, 2016

Related U.S. Application Data
(60) Provisional application No. 62/204,606, filed on Aug. 13, 2015.

(51) Int. Cl. F21V 14/00; G02B 26/00; G02F 1/31; G02B 27/30

(52) U.S. Cl. CPC F21V 14/003; G02B 27/30; G02B 26/005; G02F 1/31

(57) ABSTRACT

The examples relate to various implementations of a software configurable lighting device. Such a device, in the examples, includes a light source and an optical modulator and may include a programmable controller. The device is configurable by software, e.g. configuration information and/or programming for processing of that information to emulate a lighting distribution of a selected one of a variety of different lighting devices.

### CROSS-REFERENCE TO RELATED APPLICATION

This application claims priority of U.S. Provisional Patent Application No. 62/204,606, filed on Aug. 13, 2015 and entitled “Configurable Lighting Device Using A Light Source and Optical Modulator” the entire contents of which is incorporated herein by reference.

### TECHNICAL FIELD

The disclosed subject matter relates to lighting devices, and to configurations and/or operations thereof, whereby a lighting device having a light source and an optical modulator is configurable by software for a programmable controller, e.g. to emulate a lighting distribution of a selected one of a variety of different lighting devices.

### BACKGROUND

Electrically powered artificial lighting has become ubiquitous in modern society. Electrical lighting devices are commonly deployed, for example, in homes, buildings of commercial and other enterprise establishments, as well as in various outdoor settings.

In conventional lighting devices, the luminance output can be turned ON/OFF and often can be adjusted up or dimmed down. In some devices, e.g. using multiple colors of light emitting diode (LED) type sources, the user may be able to adjust a combined color output of the resulting illumination. The changes in intensity or color characteristics of the illumination may be responsive to manual user inputs or responsive to various sensed conditions in or about the illuminated space. The optical distribution of the light output, however, typically is fixed. Various different types of optical elements are used in such lighting devices to provide different light output distributions, but each type of device has a specific type of optic designed to create a particular light distribution for the intended application of the lighting device. The dimming and/or color control features do not affect the distribution pattern of the light emitted from the luminaire.

To the extent that multiple distribution patterns are needed for different lighting applications, multiple luminaires must be provided. To meet the demand for different appearances and/or different performance (including different distributions), a single manufacturer of lighting devices may build and sell thousands of different luminaires.

Some special purpose light fixtures, for example, fixtures designed for stage or studio type lighting, have implemented mechanical adjustments. Mechanically adjustable lenses and irises enable selectable adjustment of the output light beam shape, and mechanically adjustable gimbal fixture mounts or the like enable selectable adjustment of the angle of the fixture and thus the direction of the light output. The adjustments provided by these mechanical approaches are implemented at the overall fixture output. Such adjustments provide relatively coarse overall control and are really optimized for special purpose applications, not general lighting.

There have been more recent proposals to develop lighting devices offering electronically adjustable light beam distributions, using a number of separately selectable/controllable solid state lamps or light engines within one light fixture. In at least some cases, each internal light engine or lamp may have an associated adjustable electro-optic component to adjust the respective light beam output, thereby providing distribution control for the overall illumination output of the fixture.

Although the more recent proposals provide a greater degree of distribution adjustment and may be more suitable for general lighting applications, the outward appearance of each lighting device remains the same even as the device output light distribution is adjusted. There may also be room for still further improvement in the degree of adjustment supported by the lighting device.

There also have been proposals to use displays or display-like devices mounted in or on the ceiling to provide variable lighting. The Fraunhofer Institute, for example, has demonstrated a lighting system using luminous tiles, each having a matrix of red (R) LEDs, green (G), blue (B) LEDs and white (W) LEDs as well as a diffuser film to process light from the various LEDs. The LEDs of the system were driven to simulate or mimic the effects of clouds moving across the sky. Although use of displays allows for variations in appearance that some may find pleasing, the displays or display-like devices are optimized for image output and do not provide particularly good illumination for general lighting applications. A display typically has a Lambertian output distribution over substantially the entire surface area of the display screen, which does not provide the white light intensity and coverage area at a floor or ceiling height offered by a similarly sized ceiling-mounted light fixture. Liquid Crystal Displays (LCDs) also are rather inefficient. For example, backlights in LCD televisions have to produce almost ten times the amount of light that is actually delivered at the viewing surface.

### SUMMARY

The concepts disclosed herein improve over the art by providing software configurable lighting equipment.

The detailed description below and the accompanying drawings disclose examples of a software configurable lighting device. In such an example, the lighting device may include a light source and a controllable optical modulator coupled to receive and modulate light output from the source. This example also includes a memory, a processor-based or other type of programmable controller, coupled to control the light source and the optical modulator and coupled to have access to the memory. Executable programming for the controller is stored in the memory. Lighting device configuration information also is stored in the memory. Execution of the programming by the controller configures the lighting device to perform functions, including functions to operate the light source to provide light output from the lighting device and operate the modulator to steer and/or shape the light output from the source. The modulation distributes the light output from the lighting device to emulate a lighting distribution of a selected one of a number of types of luminaire, based on the lighting device configuration information.

The elements of the lighting device may be combined together in one relatively integral unit, e.g. in one light fixture or other type of luminaire. Alternatively, the elements of the device may be somewhat separate from each other, e.g. with the controller and possibly the memory separate from the light source and the controllable optical modulator.

In some examples, a light fixture includes a light source and means for optically, spatially modulating light output from the source. The optical, spatial modulation distributes the light output from the light fixture to emulate a lighting distribution of a selected one of a variety of types of luminaire for a general illumination application of the one type of luminaire.

A variety of spatial modulation techniques are disclosed by way of examples of the optical modulator and/or of the modulating means. The examples also encompass many different types of or combinations of light emitter for use in the light source. Control for the fixture may be incorporated into the fixture with the source and modulating means; or the control element(s) may be separate, e.g. so that one control device can control several fixtures or one or more fixtures can be controlled by the control element in one other light fixture.

In a number of examples, an artificial lighting luminaire includes a light source configured to provide artificially generated light for a general lighting application and a controllable electrowetting optic coupled to selectively, optically process the light output from the light source. In other examples, an artificial lighting luminaire includes a light source configured to provide artificially generated light for a general lighting application and a controllable liquid crystal polarization grating (LCPG) beam steering assembly.

The examples discussed below also encompass methods of operation or control of software configurable light fixtures, luminaires or other lighting devices, methods of installation of configuration information in such equipment, as well as programming and/or configuration information files for such equipment, e.g. as may be embodied in a machine readable medium.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a high-level functional block diagram of a software configurable lighting device, system or apparatus.

FIG. 2 is a high-level functional block diagram of an example of the light source and spatial modulator of a configurable lighting device.

FIG. 3 is a diagram of another example of the light source and a controllable optic serving as the spatial modulator, of a configurable lighting device.

FIG. 4 is a high-level functional block diagram of an example of the light source and spatial modulator of a configurable lighting device, which also shows an example of driver system elements to drive the source and the modulator.

FIG. 5 is a plan view of a panel type light source, enhanced with one or more sources and controllable optics for spatial modulation.

FIG. 5A is a partial cross-sectional view in the vicinity of one corner (roughly along line A-A) to show an angled arrangement of the illumination and modulation elements relative to the plane of the light panel.

FIG. 5B is an enlarged cross-sectional view along line B-B of FIG. 5, for another example where the illumination and modulation elements are perpendicular to the plane of the light panel.

FIGS. 6A to 6D are graphs of luminaire light output distributions, with FIGS. 6A and 6B respectively representing polar candela distribution and a footprint plot for a recessed downlight luminaire, and FIGS. 6C and 6D respectively representing polar candela distribution and a footprint plot a wall wash.

FIG. 7 is a high-level functional block diagram of a system for providing configuration or setting information to a software configurable lighting device, based on a user selection.

FIG. 8 is a ping-pong chart type signal flow diagram, of an example of a procedure for loading configuration information to a software configurable lighting device, in a system like that of FIG. 7.

FIGS. 9A to 9D are cross-sectional views of an electrowetting type controllable optic, in which FIGS. 9A and 9B illustrate a first selected direction of optical steering and two different states of beam shaping, and FIGS. 9C and 9D illustrate a second selected direction of optical steering and two different states of beam shaping.

FIGS. 10A and 10B are different cross sectional views of an example of another type of controllable optic that provides waveform control at the liquid interface, to provide selectable beam steering and/or beam shaping.

FIG. 11 is a simplified diagram of the liquid interface of an electrowetting type controllable optic, useful in understanding the light refraction as a beam of light passes through an electrowetting optic.

FIG. 12 is a graph of maximum deflection angle versus contact angle, for an optic based on principles illustrated in FIG. 11, showing the effects of different indices of refraction of the oil.

FIG. 13 illustrates another example of the light source and spatial modulator of a software configurable lighting device, which in this example, utilizes reflective electrowetting type controllable optics at pixels of an array forming the spatial modulator.

FIGS. 14A and 14B are cross-sectional views of a reflective electrowetting prism type controllable optic, which may be used in the modulator in the example of FIG. 13, in two different beam steering states.

FIGS. 15A and 15B are cross-sectional views of a reflective electrowetting lens type controllable optic, in two different beam shaping states.

FIG. 16 is a plan view of an array of controllable electrowetting optics.

FIG. 17 is an isometric view of a number of cells of an array of controllable electrowetting optics.

FIG. 18 is a simplified isometric view of an array of micro-electrical mechanical system (MEMS) mirrors or the like, in the form of a pixel level controllable array, that may be used as a spatial modulator in a configurable lighting device.

FIGS. 19A to 19C illustrate various aspects of another example of a pixel-level selectable beam steering array, using active, switchable Polarization Grating (PG) for spatial beam modulation of generated light.

FIGS. 20A-20D illustrates examples of the response of passive, switchable LCPGs to the application of left handed circularly polarized light and right handed circularly polarized light.

FIGS. 21A illustrates an example of a pixel of a pixel controllable light generation and spatial light distribution system using polarization gratings (PG) technology for spatial modulation.

FIGS. 21B and 21C illustrate examples of the concept of stacking PGs in an example for controlling the beam steering angle of input light, e.g. for use in the active stack portion of the pixel of FIG. 21A.

FIG. 22 is a is a simplified functional block diagram of a computer that may be configured as a host or server, for example, to supply configuration information or other data to a software configurable lighting device.

FIG. 23 is a simplified functional block diagram of a personal computer or other similar user terminal device, which may communicate with a software configurable lighting device.

FIG. 24 is a simplified functional block diagram of a mobile device, as an alternate example of a user terminal device, for possible communication with a software configurable lighting device.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The examples discussed below and shown in the drawings improve over the art by providing software configurable lighting equipment. Human habitation often requires augmentation of natural ambient lighting with artificial lighting. For example, many office spaces, commercial spaces and/or manufacturing spaces require task lighting even when substantial amounts of natural ambient lighting are available. The configurable lighting techniques under consideration here may be applied to any indoor or outdoor region or space that requires at least some artificial lighting. The lighting equipment involved here provides the main artificial illumination component in the space, rather than ancillary light output as might be provided by a display, or by or in association with a sound system, or the like. As such, the illumination from the fixtures, lamps, luminaires or other types of lighting devices is the main artificial illumination that supports the purpose of the space, for example, the lighting that alone or in combination with natural lighting provides light sufficient to allow occupants in the space to perform the normally expected task or tasks associated with the planned usage of the space. Often, such lighting is referred to as “general” lighting or “general” illumination.

The various examples disclosed herein relate to a lighting device, such as a software configurable light fixture or other luminaire for general illumination that is configurable to emulate a lighting distribution of a selected one of a variety of different lighting devices. In the examples, such a device or fixture includes a light source and either a controllable optical modulator or a means for optically, spatially modulating light output from the source. The means or modulator selectively, spatially modulates light output from the source to distribute the light output to emulate a lighting distribution of a selected one of a number of types of luminaire for a general illumination application.

The term “lighting device” as used herein is intended to encompass essentially any type of device that processes power to generate light, for example, for illumination of a space intended for use of or occupancy or observation, typically by a living organism that can take advantage of or be affected in some desired manner by the light emitted from the device. However, a lighting device may provide light for use by automated equipment, such as sensors/monitors, robots, etc. that may occupy or observe the illuminated space, instead of or in addition to light provided for an organism. A lighting device, for example, may take the form of a lamp, light fixture or other luminaire that incorporates a source, where the source by itself contains no intelligence or communication capability (e.g. LEDs or the like, or lamp (“regular light bulbs”) of any suitable type) and the associated spatial modulator. Alternatively, a fixture or luminaire may be relatively dumb but include a source device (e.g. a “light bulb”) that incorporates the intelligence and spatial modulation capabilities discussed herein. In most examples, the lighting device(s) illuminate a service area to a level useful for a human in or passing through the space, e.g. regular illumination of a room or corridor in a building or of an outdoor space such as a street, sidewalk, parking lot or performance venue. However, it is also possible that one or more lighting devices in or on a particular premises served by a system of lighting devices have other lighting purposes, such as signage for an entrance or to indicate an exit. Of course, the lighting devices may be configured for still other purposes, e.g. to benefit human or non-human organisms or to repel or even impair certain organisms or individuals. The actual source in each lighting device may be any type of artificial light emitting unit.

The lighting devices discussed by way of examples below generally provide configurable artificial lighting, typically in support of any one of a number of possible general lighting applications for a luminaire of the like. Hence, a number of the examples below include one or more non-imaging type light sources that do not generate a visible image representation of information as might otherwise be perceptible to a person observing the generated light. The modulated light output in the examples will provide a selected illumination light distribution, for a general lighting application.

The term “coupled” as used herein refers to any logical, physical, optical or electrical connection, link or the like by which forces, energy, signals or other actions produced by one system element are imparted to another “coupled” element. Unless described otherwise, coupled elements or devices are not necessarily directly connected to one another and may be separated by intermediate components, elements or communication media that may modify, manipulate or carry the signals. The “coupled” term applies both to optical coupling and to electrical coupling. For example, the controllable optical modulator is coupled by any of various available optical techniques to receive and modulate light output from the source, whereas a processor or the like may be coupled to control and/or exchange instructions or data with other elements of a device or system via electrical connections, optical connections, electromagnetic communications, etc.

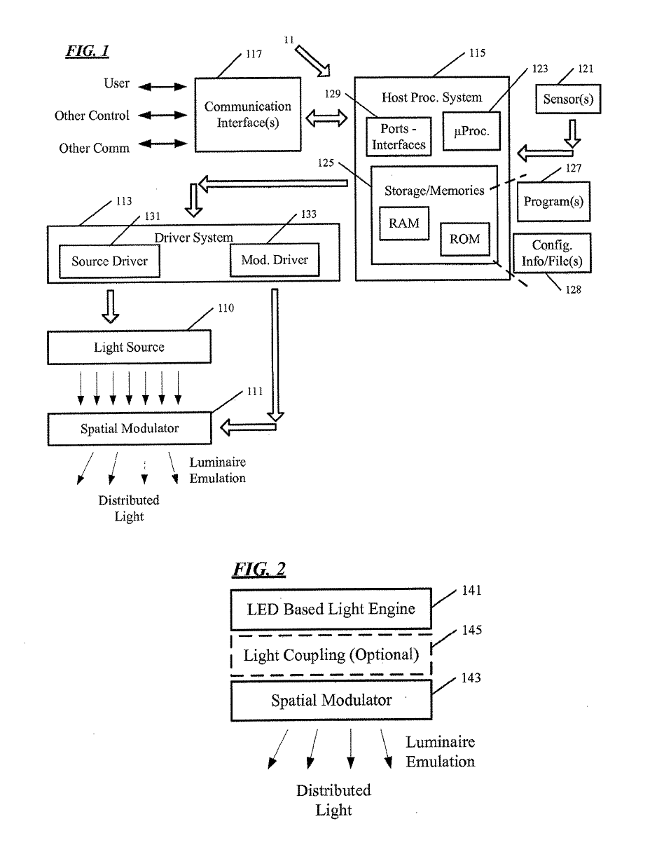

Reference now is made in detail to the examples illustrated in the accompanying drawings and discussed below. FIG. 1 illustrates a high-level functional block diagram of a lighting device 11, including a light source 110 and means for modulating the light output of the source 110, in this example, in the form of a spatial modulator 111. Although virtually any source of artificial light may be used as the source 110, in the examples, the source 110 typically is a non-imaging type of light source, e.g. not an imaging source that might provide display or other similar image-based output functionalities. A variety of suitable light generation sources are indicated below. The description also mentions a variety of suitable modulation means, and several examples of spatial modulation techniques are described in detail and illustrated in later drawings. The type of spatial modulator 111 chosen for use with the particular source 110 enables the modulator 111 to optically, spatially modulate the light output from the source 110 to distribute the light output from the lighting device 11 to emulate a lighting distribution of a selected one of any number of different types of luminaire for a general illumination application of a selected type of luminaire.

Examples of the light source include various conventional lamps, such as incandescent, fluorescent or halide lamps; one or more light emitting diodes (LEDs) of various types, such as planar LEDs, micro LEDs, micro organic LEDs, LEDs on gallium nitride (GaN) substrates, micro nanowire or nanorod LEDs, photo pumped quantum dot (QD) LEDs, micro plasmonic LED, micro resonant-cavity (RC) LEDs, and micro photonic crystal LEDs; as well as other sources such as micro super luminescent Diodes (SLD) and micro laser diodes. Of course, these light generation technologies are given by way of non-limiting examples, and other light generation technologies may be used to implement the source 110.

In some examples, the light source 110 is a non-imaging type of light source in that it provides light for illumination or the light but does not provide a perceptible image display when the source or the device is viewed directly by an observer. The source 110 may use a single emitter to generate light, or the source 110 may combine light from some number of emitters that generate the light. A lamp or ‘light bulb’ is an example of a single source, an LED light engine provide a single combine output for a single source but typically combines light from multiple LED type emitters within the single engine. Many types of light sources provide an illumination light output that generally appears uniform to an observer, although there may be some color or intensity striations, e.g. along an edge of a combined light output. For purposes of the present examples, however, the appearance of the light source output may not be strictly uniform across the output area or aperture of the source 110. For example, although the source 110 may use individual emitters or groups of individual emitters to produce the light generated by the overall source 110; depending on the arrangement of the emitters and any associated mixer or diffuser, the light output may be relatively uniform across the aperture or may appear pixelated to an observer viewing the output aperture. The individual emitters or groups of emitters may be separately controllable, for example to control intensity or color characteristics of the source output. As such, the non-imaging source 110 may or may not be pixelated for control purposes. Even if pixelated for appearance and control purposes, the emitter arrangement and the attendant control need not produce a perceptible image like a display in the output of the source 110 and/or via the distributed output of the lighting device 11. In some non-display example, the pixelated output of the source 110 and/or of the device 11 for luminaire distribution emulation may provide a visible light pattern, such as a static or variable color mosaic.

A variety of spatial modulation techniques may be used (or used in combination) to implement the optical spatial modulator 111. Examples of controllable optical modulators that may be used as the spatial modulator 111 or other modulator means include micro/nano-electro-mechanical systems (MEMS/NEMS) based dynamic optical beam control optics, electrowetting based dynamic optical beam control, electrochromic gradient based control, microlens based passive beam control, passive control using segment control (y-y area and pixels), holographic films, and switchable diffusers and/or gratings based on LCD materials. Of course, these modulation technologies are given by way of non-limiting examples, and other modulation techniques may be used to implement the spatial modulator 111. The optical modulator technology, the number of elements/cells/pixels of the spatial modulator 111 and/or the arrangement of the spatial modulator 111 relative to the light source 110 for a given implementation of the device 110 may be chosen so that the modulated light output selectively achieves various possible luminaire output distributions. The configurable lighting device 11, however, need not operate as a display, and therefore the modulated light output need not present any particular image or provide any display representing particular humanly visible information.

For convenience, FIG. 1 shows an arrangement of the light source 110 and the spatial modulator 111 that corresponds most closely to use of a transmissive type modulator, where the modulator passes light through but modulates distribution of the transmitted light. Similar arrangements are shown for convenience in several of the later drawings, as well. Those skilled in the art will appreciate that other types of source/modulator arrangements may be used, for example, in which the modulator reflects light instead of or in addition to transmissive passage of the light being spatially modulated.

The first drawing also provides an example of an implementation of the high layer logic and communications elements and one or more drivers to drive the source 110 and the spatial modulator 111 to provide a selected light output distribution, e.g. for a general illumination application. As shown in FIG. 1, the lighting device 11 includes a driver system 113, a host processing system 115, one or more sensors 121 and one or more communication interface(s) 117.

The host processing system 115 provides the high level logic or “brain” of the device 11. In the example, the host processing system 115 includes data storage/memories 125, such as a random access memory and/or a read-only memory, as well as programs 127 stored in one or more of the data storage/memories 125. The data storage/memories 125 store various data, including lighting device configuration information 128 or one or more configuration files containing such information, in addition to the illustrated programming 127. The host processing system 115 also includes a central processing unit (CPU), shown by way of example as a microprocessor (μP) 123, although other processor hardware may serve as the CPU.

The ports and/or interfaces 129 couple the processor 123 to various elements of the device illogically outside the host processing system 115, such as the driver system 113, the communication interface(s) 117 and the sensor(s) 121. For example, the processor 123 by accessing programming 127 in the memory 125 controls operation of the driver system 113 and other operations of the lighting device 11 via one or more of the ports and/or interfaces 129. In a similar fashion, one or more of the ports 129 enable the processor 123 of the host processing system 115 to use and communicate externally via the interfaces 117; and the one or more of the ports 129 enable the processor 123 of the host processing system 115 to receive data regarding any condition detected by a sensor 121, for further processing.

In the examples, based on its programming 127, the processor 123 processes data retrieved from the memory 123 and/or other data storage, and responds to light output parameters in the retrieved data to control the light generation and distribution system 111. The light output control also may be responsive to sensor data from a sensor 121. The light output parameters may include light intensity and light color characteristics in addition to spatial modulation (e.g. steering and/or shaping and the like for achieving a desired spatial distribution).

As noted, the host processing system 115 is coupled to the communication interface(s) 117. In the example, the communication interface(s) 117 offer a user interface function or communication with hardware elements providing a user interface for the device 11. The communication interface(s) 117 may communicate with other control elements, for example, a host computer of a building control and automation system (BCAS). The communication interface(s) 117 may also support device communication with a variety of other systems of other parties, e.g. the device manufacturer for maintenance or an on-line server for downloading of virtual luminaire configuration data.

As outlined earlier, the host processing system 115 also is coupled to the driver system 113. The driver system 113 is coupled to the light source 110 and the spatial modulator 111 to control one or more operational parameter(s) of the light output generated by the source 110 and to control one or more parameters of the modulation of that light by the spatial modulator 111. Although the driver system 113 may be a single integral unit or implemented in a variety of different configurations having any number of internal driver units, the example of system 113 includes a light source driver circuit 131 and a spatial modulator driver 133. The drivers 131, 133 are circuits configured to provide signals appropriate to the respective type of source 110 and/or modulator 111 utilized in the particular implementation of the device 11, albeit in response to commands or control signals or the like from the host processing system 115.

The host processing system 115 and the driver system 113 provide a number of control functions for controlling operation of the lighting device 11. In a typical example, execution of the programming 127 by the host processing system 115 and associated control via the driver system 113 configures the lighting device 11 to perform functions, including functions to operate the light source 110 to provide light output from the lighting device and to operate the spatial modulator 111 to steer and/or shape the light output from the source 110 so as to distribute the light output from the lighting device 10 to emulate a lighting distribution of a selected one of a number of types of luminaire, based on the lighting device configuration information 128.

Apparatuses implementing functions like those of device 11 may take various forms. In some examples, some components attributed to the lighting device 11 may be separated from the light source 110 and the spatial modulator 111. For example, an apparatus may have all of the above hardware components on a single hardware device as shown or in different somewhat separate units. In a particular example, one set of the hardware components may be separated from the light source 110 and the spatial modulator 111, such that the host processing system 115 may run several similar systems of sources and modulators from a remote location. Also, one set of intelligent components, such as the microprocessor 123, may control/drive some number of driver systems 113 and associated light sources 110 and spatial modulators 111. It also is envisioned that some lighting devices may not include or be coupled to all of the illustrated elements, such as the sensor(s) 121 and the communication interface(s) 117. For convenience, further discussion of the device 11 of FIG. 1 will assume an intelligent implementation of the device that includes at least the illustrated components.

In addition, the device 11 is not size restricted. For example, each device 11 may be of a standard size, e.g., 2-feet by 2-feet (2×2), 2-feet by 4-feet (2×4), or the like, and arranged like tiles for larger area coverage. Alternatively, the device 11 may be a larger area device that covers a wall, a part of a wall, part of a ceiling, an entire ceiling, or some combination of portions or all of a ceiling and wall.

In an operation example, the processor 123 receives a configuration file 128 via one or more of communication interfaces 117. The configuration file 128 indicates a user selection of a virtual luminaire light distribution to be provided by the configurable lighting device 11. The processor 123 may store the received configuration file 128 in storage/memories 125. Each configuration file includes software control data to set the light output parameters of the software configurable lighting device 11 at least with respect to optical spatial modulation. The configuration information in the file 128 may also specify operational parameters of the light source 110, e.g. illumination related parameters such as light intensity, light color characteristic and the like. The processor 123 by accessing programming 127 and using software configuration information 128, from the storage/memories 125, controls operation of the driver system 113, and through that system 113 controls the light source 110 and the spatial optical modulator 111. For example, the processor 123 obtains distribution control data from a configuration file 128, and uses that data to control the modulation driver 133 to cause modulator 111 to optically spatially modulate output of the light source 110 to produce a selected light distribution. In this way, the configurable lighting device 11 achieves a user selected light distribution for a general illumination application of a luminaire, e.g. selected from among any number of luminaire emulations within the operational capabilities of the lighting device 11.

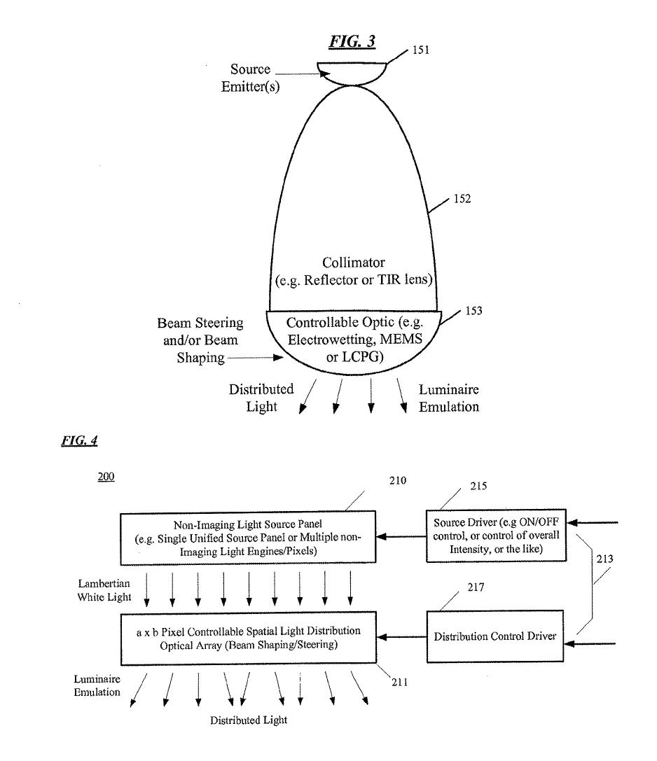

FIG. 2 illustrates an example of a LED type light engine 141, serving as the light source (110 of FIG. 1) and a spatial modulator 143, for use in a light fixture or other type of configurable lighting device.

For general lighting applications, many manufacturers have developed LED sub-assemblies referred to as “LED light engines” that are readily adaptable to use in various luminaires. The light engine typically includes some number of LEDs that together produce a specified lumen output of a specified color characteristic or controllable range thereof, e.g. white light of a particular value or range for CRI or R9. The light engine also includes the supporting circuit board, heat sink and any additional housing for the LEDs. The light engine may also include a diffuser and/or the driver circuitry appropriate to provide drive current to the LEDs of the light engine. Any of a wide range of LED light engine designs may be used in an implementation of a software configurable lighting device. In such an example, a LED based light engine 141 produces light output, which is coupled to the spatial modulator 143.

In this example, one such spatial modulator 143 modulates the entire cross-section of the output of the light from the LED light engine 141. In such an implementation, the spatial modulator 143 may be a single controllable device extending across the output aperture of the LED based light engine 141, in which case drive of the one modulator 143 causes the modulator 143 to implement an integral controllable steering or shaping of the entire output of the LED based light engine 141. Alternatively, the spatial modulator 143 may be subdivided into pixels, e.g. in a matrix array arrangement extending across the output aperture of the LED based light engine 141, in which case different individual or sub-modulators at the pixels of the array spatially modulate different portions of the light output from the LED based light engine 141. If the associated driver (e.g. 133 in FIG. 1) individually controls the pixels of such a spatial modulator 143 different beam outputs from the LED based light engine 141 can be independently shaped or steered. As used herein, pixels refer to individually controllable units or cells in a matrix or array, for example, together forming the optical spatial modulator 143, as opposed to individual points in a picture or other type of image. In this example, the modulated light output of the overall device, from the output of pixel array implementation of the spatial modulator 143, provides the selected illumination light distribution, for a general lighting application. The spatial modulator 143 may use any of the modulation technologies outlined earlier, either to implement a single modulator device across the aperture or to implement any or all of the pixels of an array of modulator cells.

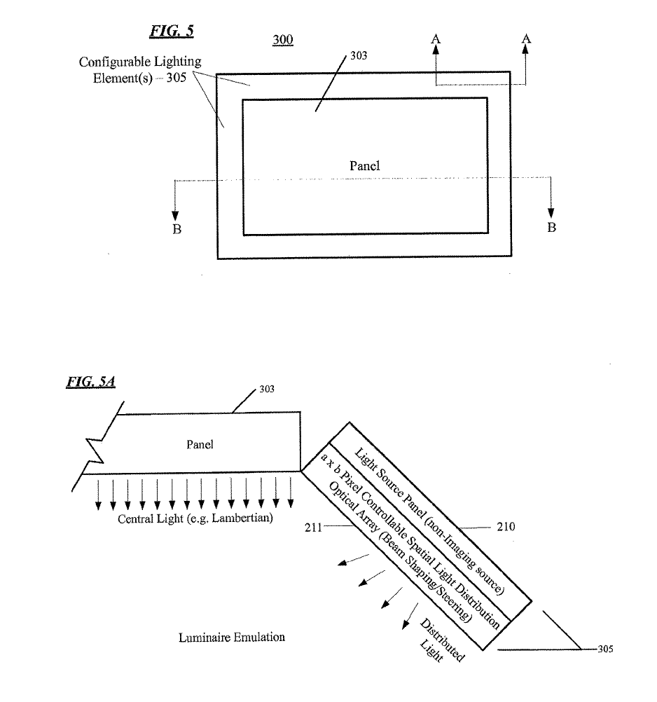

Depending on the configuration of the LED based light engine 141 and the spatial modulator 143, the non-imaging type light output from engine 141 may be supplied directly to an optical input of the spatial modulator 143. As an option, however, the device/system of FIG. 2 may further include a light coupling element 145 to enhance the coupling of the light output from the LED based light engine 141 to the optical input of the spatial modulator 143. For example, overall optical efficiency may be enhanced by use of a coupling 145 that improves extraction of light from the aperture of the particular type of engine 141 and/or reduces coupling loss at the optical input of the spatial modulator 143. As discussed more with respect to FIG. 3, it may also be desirable to use a reflector or other optical element to collimate the light output from the LED based light engine 141 to facilitate steering or shaping of the light by the spatial modulator 143.

As discussed above relative to FIG. 1, however, the distributed output of the device/system of FIG. 2, from the modulator 143, provides a light distribution that emulates a distribution of a luminaire for a general lighting application. Since the modulator 143 is controllable, e.g. by a host processing system or other type of controller, the distribution may be selectively changed to emulate any desired luminaire distribution within the range of capabilities of the particular modulator design used for element 143 of the device.

FIG. 3 is a diagram of another example of the light source and a controllable optic serving as the spatial modulator, of a software configurable lighting device. For convenience, this example shows a generic light source 151 formed of one or more emitters, which may be a light generation device or system of any of the types described above relative to source 110 in FIG. 1. In this example, the lighting device includes a collimator 152. The collimator 152 receives the light output from the source 151 and collimates that light into more of a beam shape. The degree of collimation depends on the configurations of the source 151 and the collimator 152. Examples of collimators include parabolic mirrors and total internal reflection (TIR) lenses, although a variety of other types of collimator technologies may be used.

The collimator 152 therefore supplies a beam of light to an input of the controllable optic 153 that serves as the optical spatial modulator in the example of FIG. 3. Much like the earlier examples the spatial modulator/optic 153 is configured by control via the higher layer logic modulate the collimated light to selectively emulate any desired luminaire distribution within the range of capabilities of the particular modulator design used for element 153 of the device. The collimated light provided by the collimator 152, for example, may facilitate use of several types of technologies for the controllable optic 153 of the spatial modulator, such as one or more electrowetting optics, MEMS or NEMS optics, or switchable liquid crystal polarization grating (LCPG) beam steering assemblies. Such controllable optics may offer pixel level variable control or may provide unified singular modulation control across the output of the collimator 152.

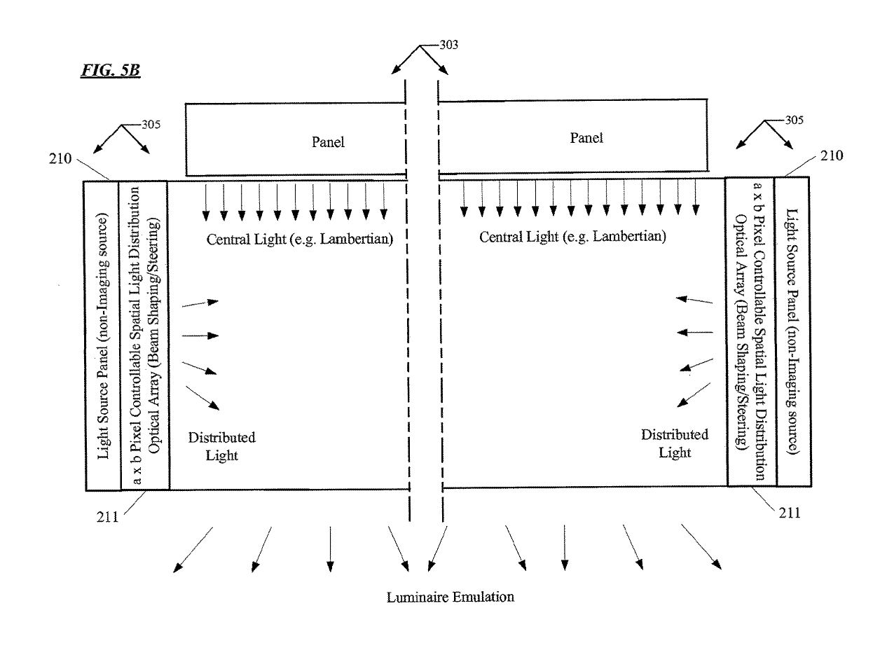

Although the discussions of FIGS. 1 to 3 included spatial modulation across the entire output aperture of the source (non-pixelated), the discussion also encompassed spatial modulation techniques for the modulator that may support pixel level control of the modulation for distribution control. It may be helpful to consider an example of such control in somewhat more detail. For that purpose, FIG. 4 is a high-level functional block diagram of an example of a lighting device 200 that includes a non-imaging light source 210 and a pixelated spatial modulator 211 of a configurable lighting device, which also shows an example of driver system elements to drive the source and the modulator.

In this example, the source 210 may take the form of a light panel, such as a 2×2 or 2×4 panel similar to light panel type fixtures used for general illumination type applications of artificial lighting. As in the earlier examples, the light source panel 210 may provide a relatively uniform light output across the output surface of the panel or a somewhat striated or pixelated light output across the output surface of the panel. As in the earlier discussions, however, the light source panel 210 is a non-imaging type source.

In FIG. 4, the configurable lighting device 200 includes an a×b pixel controllable spatial light distribution optical array 211 as the spatial modulator. In this example, the modulated light output of the overall device, from the output of pixel array implementation of the spatial modulator array 211, need not support a display function. Control of the modulation by the pixels of the spatial light distribution optical array 211 causes the array 211 to spatially modulate light from the source panel 210 and thereby distribute the light output from the lighting device 200 in a manner to emulate a lighting distribution of a selected one of a variety of types of luminaire for a general illumination application of the one type of luminaire.

The variables a and b represent the number of controllable rows and columns of pixels in the array 211. The variables a and b are integers, and may or may not be equal. For example, the variables a and b may be 1024, or a may be 1280 where b may be 720, or the like.

There does not have to be a 1 to 1 correspondence between the number of rows and columns of the pixels of the spatial light distribution optical array 211. Also, if there are pixels of some kind within the non-imaging source panel 210, there does not have to be a 1 to 1 correspondence between the number of pixels in the source panel 210 and the number of pixels in the pixel controllable spatial light distribution optical array 211 or between the sizes of the pixels of the non-imaging light source panel 210 and the spatial light distribution optical array 211.

For convenience, FIG. 4 shows an arrangement of the light source panel 210 and the pixelated spatial modulator array 211 that corresponds most closely to use of transmissive type modulator pixels, where the modulator pixels pass light through but spatially modulate transmitted light beams. Those skilled in the art will appreciate that other types of source/modulator arrangements may be used, for example, in which the modulator pixels reflect light beams instead of or in addition to transmissive passage of the light beams being spatially modulated.

In the example shown in FIG. 4, the lighting device 200 includes or is otherwise coupled to a driver system 213. For example, a system like device 200 may take the form of a lighting fixture that includes the source panel 210, the spatial light distribution optical array 211, a source driver 215 and a distribution control driver 217.

The source driver 215 is a circuit suitable to provide drive signals to the particular implementation of the light generation source panel 210. The distribution control driver 217 is a circuit suitable to provide drive signals to selectively operate the spatial modulators at the pixels of the particular implementation of the controllable spatial light distribution optical array 211. Each of the drivers 215, 217 is configured to receive and respond to respective commands or control signals from the higher layer logic associated with the device 200, such as the host processor system 115 of FIG. 1 or the like.

The source and modulator of a software configurable lighting device like those of any of the lighting devices disclosed herein may be used in combination with other light sources, e.g. as part of the same fixture. In our examples on this point, the light source and the pixelated spatial modulator array together form a configurable lighting element, which in turn is combined with the other source(s). Although the additional source(s) may have configurable lighting capabilities, further discussion of this type of combinatorial approach will concentrate on examples where the additional source(s) do not themselves provide spatial modulation for configurable light distribution outputs.

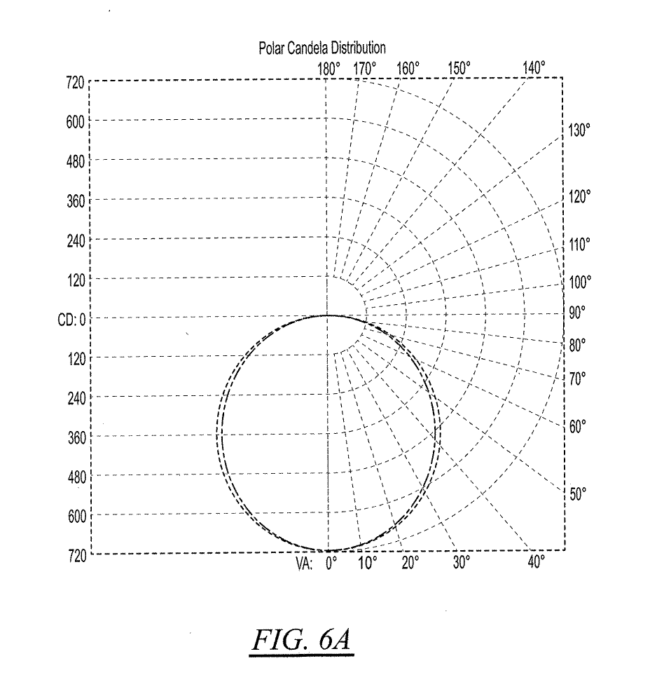

Although the light source and spatial modulator may be of any of the various respective types described here, for discussion purposes, we will use an example of a fixture 300 that combines a source and a modulator like those of FIG. 4 as one or more configurable lighting elements, used together with an additional light source. For this purpose, FIG. 5 is a plan view of a light source, enhanced by combination thereof with one or more additional configurable lighting elements, each of which includes a light source and one or more controllable optics. As will be discussed with respect to the more specific examples of FIGS. 5A and 5B, each of the added sources is a light source panel, and each of the spatial modulators is a pixelated spatial modulator array (compare to FIG. 4).

With specific reference to drawing FIG. 5, the light fixture 300 includes a central light source 303. Although the central light source may be virtually any type of illumination light generation device, including various types of displays. In the example, however, the source 303 is another instance of a non-imaging panel type source, similar to the panel sources discussed above relative to 210 of FIG. 4. To support distribution modulation, however, the fixture 300 is enhanced by the addition of configurable lighting element(s) 305 that include sources and modulation arrays (FIGS. 5A and 5B).

In the example of FIG. 5, the central source 303 is rectangular, therefore, the added configurable lighting element(s) 305 are located along one or more of (or all four of in the example) the edges of the central source panel 303. Sources 303 of different shapes may have the configurable lighting element(s) 305 contoured in a corresponding manner to fit along peripheral sections of the different shapes of the sources 303. Although one configurable lighting element 305 is shown along each edge of the rectangular central panel type light source 303, for convenience, there may be two or more configurable lighting elements 305 of the same or different type along some part or all of each edge of the central panel type light source 303.

As shown in the cross-sectional views of FIGS. 5A and 5B each of the configurable lighting elements 305 is formed by a combination of a non-imaging light source panel 210 and a spatial light distribution optical array 211 of the type illustrated in FIG. 4. Each combination of a non-imaging light source panel 210 and a spatial light distribution optical array 211 operates and is controlled essentially as described by way of example above with regard to earlier configurable lighting devices, to produce a distributed light output.

In the example of FIGS. 5 to 5B, the light from the central panel type light source 303 provides a relatively uniform output distribution (e.g. Lambertian distribution) over a specified angular field of illumination, although the source 303 may produce any other suitable type of light output distribution. The intensity and/or color characteristics of the light output of the central panel type light source 303 may be selectively controlled, however, there is no direct spatial modulation of the output of that light source 303. Light, however, is additive. The light outputs from the configurable lighting on elements 305 are selectively modulated as in the earlier examples. Hence, in an example like that shown in FIGS. 5 to 5B, the combination of light from the central panel 303 and light from the modulated distributed light outputs from the configurable lighting elements 305 can be controlled to emulate a lighting distribution of a selected one of a variety of different luminaires, much like in the examples of FIGS. 1-4.

The non-imaging light source panel 210 and spatial light distribution optical array 211 forming each configurable lighting element 305 may be positioned at any desired angle relative to the output surface or aperture of the central panel 303. FIG. 5A, for example, illustrates an arrangement in which the non-imaging light source panel 210 and spatial light distribution optical array 211 are mounted with their emission surfaces/apertures at an obtuse angle relative to the plane of the output surface or aperture of the central panel 303. In such an arrangement, an observer looking at the fixture 300 would see a plan view (like FIG. 5) in which the configurable lighting elements 305 appear as additional emission sources along the edges of the central panel 303. As an alternative example, FIG. 5B illustrates an arrangement in which the non-imaging light source panel 210 and spatial light distribution optical array 211 are mounted with their emission surfaces/apertures approximately perpendicular to the plane of the output surface or aperture of the central panel 303. In this later arrangement, an observer looking at the fixture 300 would mainly see the end surfaces of the configurable lighting elements 305 along the edges of the central panel 303 in a plan type view similar to FIG. 5.

The configurable lighting elements 305 may abut or adjoin the respective edge(s) of the central panel type light source 303, as illustrated by way of example in FIG. 5A. For some general lighting applications, however, the configurable lighting elements 305 may be separated somewhat from the respective edge(s) of the central panel type light source 303, as illustrated by way of example in FIG. 5B.

In the examples we have been considering so far, the controller configures the lighting device 11 to provide light output from the lighting device 11 and to operate the modulator 111 to steer and/or shape the light output from the source so as to emulate a lighting distribution of a selected one of a number of types of luminaire, based on the lighting device configuration information. To help understand these functions, it may be useful to consider some examples of lighting distribution of a couple of examples of different type of physical luminaires.

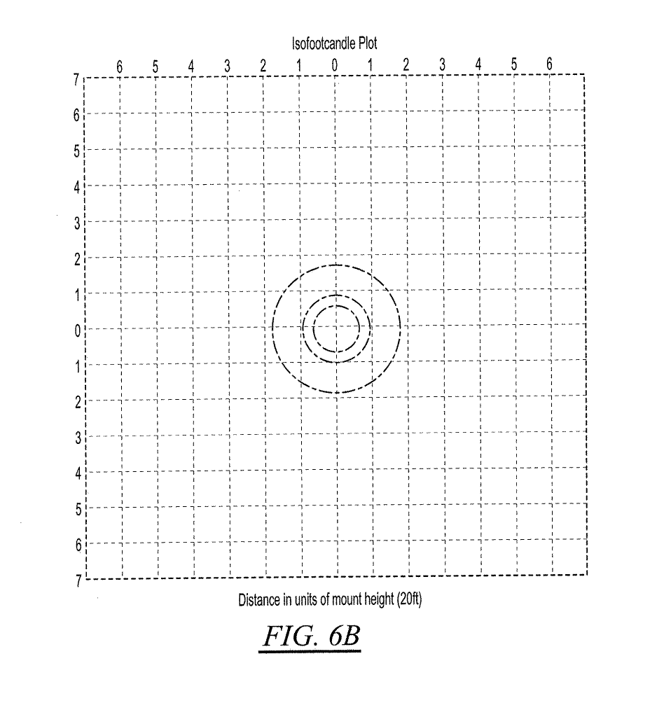

FIGS. 6A to 6D are graphs of luminaire light output distributions. The distributions shown represent distributions of actual lighting devices. FIG. 6A depicts a polar candela distribution of a recessed troffer type downlighting luminaire, and 6B is a footprint plot for the recessed troffer luminaire at different distances from the mounted luminaire. Similarly, FIG. 6C depicts a polar candela distribution of a wall wash type light fixture, and FIG. 6D is a footprint plot for the wall wash fixture. Comparison of FIGS. 6A and 6C shows differences between the angular outputs of light from the two different types of luminaires, and comparison of FIGS. 6A and 6C shows differences between the footprints of the illumination emitted from the two different types of luminaires. A software configurable lighting device 11 like any of those discussed above relative to FIGS. 1-5B, can selectively provide different output distributions, e.g. different angular distributions and/or different footprints at specified distances from the lighting device. One such software configurable lighting device 11, for example, may provide a downlight distribution analogous to the distribution performance of the recessed downlight luminaire represented by the diagrams of FIGS. 6A and 6B, based on a corresponding first set of configuration information. A different software configurable lighting device, or the same software configurable lighting device at a different time, may provide a wall wash distribution analogous to the distribution performance of the wall wash type luminaire represented by the diagrams of FIGS. 6C and 6D, based on a corresponding second set of configuration information.

The selective light output distributions provided by the software configurable lighting device(s) 11 in examples related to FIGS. 6A to 6D emulate the distributions of actual luminaires, although they need not match the actual luminaire distributions to any particular degree of precision. A variance of 10 to 20 percent for a distribution parameter of distributed light output of a lighting device 11, from a corresponding parameter of an actual or virtual distribution selected for emulation, may suffice for many typical general illumination type lighting applications. Although not necessarily a precise copy of an actual light output distribution, a distribution emulation by a software configurable lighting device 11 is sufficient to achieve an intended design objective of a general artificial lighting application of a selected type of luminaire, based on the lighting device configuration information for the particular emulated luminaire, e.g. to achieve a suitable downlight distribution or a suitable wall wash distribution similar to the fixtures that offer the distributions illustrated in FIGS. 6A to 6D.

Also, the downlight and wall wash distributions are given only by way of non-limiting examples for teaching purposes, and it is intended that any given software configurable lighting device 11 can emulate a wide range of luminaire distributions for any number of different general lighting applications. Furthermore, the emulated luminaire distributions may correspond to actual luminaires like those in the examples discussed relative to FIGS. 6A to 6D, or a selected luminaire distribution emulated by one or more software configurable lighting devices may be a virtual luminaire distribution designed for a particular lighting device application that does not correspond to any otherwise existing physical luminaire design.

A software configurable lighting device 11 (e.g. FIG. 1) of the type described herein can store configuration information for one or more luminaire output distributions. A user may define the parameters of a distribution in the lighting device 11, for example, via a user interface on a controller or user terminal (e.g. mobile device or computer) in communication with the software configurable the lighting device 11. In another example, the user may select or design a distribution via interaction with a server, e.g. of a virtual luminaire store; and the server communicates with the software configurable the lighting device 11 to download the configuration information for the selected/designed distribution into the lighting device 11. When the software configurable lighting device 11 stores configuration information for a number of lighting distributions, the user operates an appropriate interface to select amongst the distributions available in the software configurable the lighting device 11. Selections can be done individually by the user from time to time or in an automatic manner selected/controlled by the user, e.g. on a user's desired schedule or in response to user selected conditions such as amount of ambient light and/or number of occupants in an illuminated space.

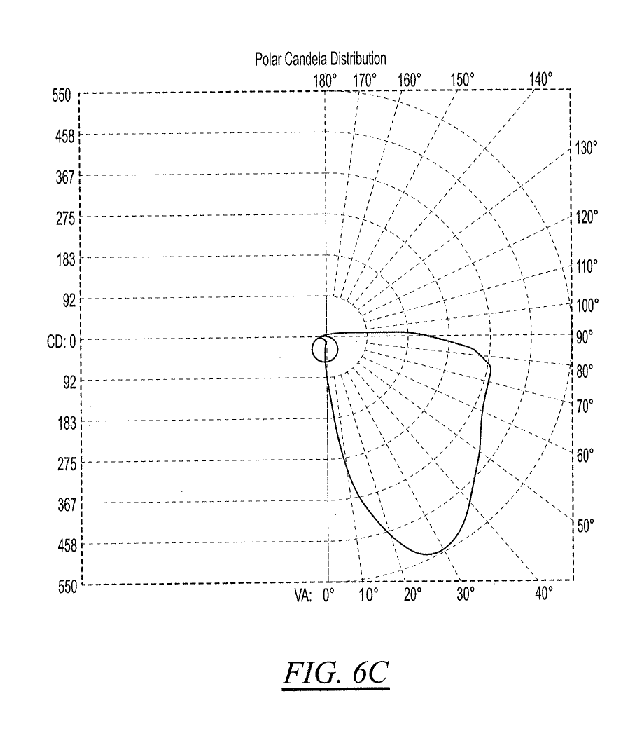

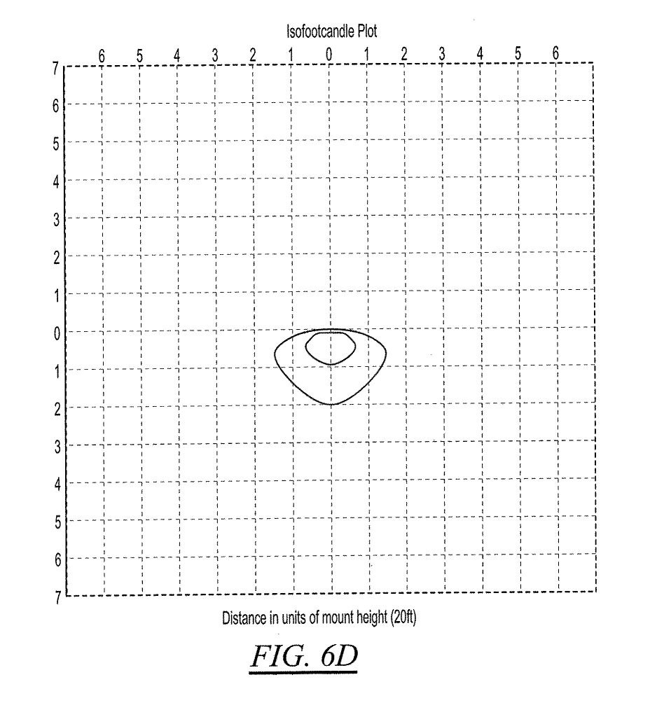

To provide examples of these methodologies and functionalities and associated software aspects of the technology, it may be helpful to consider a high-level example of a system including software configurable lighting devices 11 (FIG. 7), and later, an example of a possible process flow for obtaining and installing configuration information (FIG. 8).

FIG. 7 illustrates a system 10 for providing configuration or setting information, e.g. based on a user selection, to a software configurable lighting device (LD) 11 of any of the types discussed herein. For purposes of discussion of FIG. 7, we will assume that software configurable lighting device 11 generally corresponds in structure to the block diagram illustration of a device 11 in FIG. 1.

In FIG. 7, the software configurable lighting device 11, as well as some other elements of system 10, are installed within a space or area 13 to be illuminated at a premises 15. The premises 15 may be any location or locations serviced for lighting and other purposes by such system of the type described herein. Most of the examples discussed below focus on indoor building installations, for convenience, although the system may be readily adapted to outdoor lighting. Hence, the example of system 10 provides configurable lighting and possibly other services in a number of service areas in or associated with a building, such as various rooms, hallways, corridors or storage areas of a building and an outdoor area associated with a building. Any building forming or at the premises 15, for example, may be an individual or multi-resident dwelling or may provide space for one or more enterprises and/or any combination of residential and enterprise facilities. A premises 15 may include any number of such buildings, and in a multi-building scenario the premises may include outdoor spaces and lighting in areas between and around the buildings, e.g. in a campus configuration.

The system elements, in a system like system 10 of FIG. 7, may include any number of software configurable lighting devices 11 as well as one or more lighting controllers 19. Lighting controller 19 may be configured to provide control of lighting related operations (e.g., ON/OFF, intensity, brightness) of any one or more of the lighting devices 11. Alternatively, or in addition, lighting controller 19 may be configured to provide control of the software configurable aspects of lighting device 11, as described in greater detail below. That is, lighting controller 19 may take the form of a switch, a dimmer, or a smart control panel including a user interface depending on the functions to be controlled through device 19. The lighting system elements may also include one or more sensors 12 used to control lighting functions, such as occupancy sensors or ambient light sensors. Other examples of sensors 12 include light or temperature feedback sensors that detect conditions of or produced by one or more of the lighting devices. If provided, the sensors may be implemented in intelligent standalone system elements such as shown at 12 in the drawing, or the sensors may be incorporated in one of the other system elements, such as one or more of the lighting devices 11 and/or the lighting controller 19.

The on-premises system elements 11, 12, 19, in a system like system 10 of FIG. 7, are coupled to and communicate via a data network 17 at the premises 15. The data network 17 in the example also includes a wireless access point (WAP) 21 to support communications of wireless equipment at the premises. For example, the WAP 21 and network 17 may enable a user terminal for a user to control operations of any lighting device 11 at the premises 13. Such a user terminal is depicted in FIG. 7, for example, as a mobile device 25 within premises 15, although any appropriate user terminal may be utilized. However, the ability to control operations of a lighting device 11 may not be limited to a user terminal accessing data network 17 via WAP 21 or other on-premises access to the network 17. Alternatively, or in addition, a user terminal such as laptop 27 located outside premises 15, for example, may provide the ability to control operations of one or more lighting devices 11 via one or more other networks 23 and the on-premises network 17. Network(s) 23 includes, for example, a local area network (LAN), a metropolitan area network (MAN), a wide area network (WAN) or some other private or public network, such as the Internet.

For lighting operations, the system elements for a given service area (11, 12 and/or 19) are coupled together for network communication with each other through data communication media to form a portion of a physical data communication network. Similar elements in other service areas of the premises are coupled together for network communication with each other through data communication media to form one or more other portions of the physical data communication network at the premises 15. The various portions of the network in the service areas in turn are coupled together to form a data communication network at the premises, for example to form a LAN or the like, as generally represented by network 17 in FIG. 7. Such data communication media may be wired and/or wireless, e.g. cable or fiber Ethernet, Wi-Fi, Bluetooth, or cellular short range mesh. In many installations, there may be one overall data communication network 17 at the premises. However, for larger premises and/or premises that may actually encompass somewhat separate physical locations, the premises-wide network 17 may actually be built of somewhat separate but interconnected physical networks utilizing similar or different data communication media.

System 10 also includes server 29 and database 31 accessible to a processor of server 29. Although FIG. 7 depicts server 29 as located outside premises 15 and accessible via network(s) 23, this is only for simplicity and no such requirement exists. Alternatively, server 29 may be located within premises 15 and accessible via network 17. In still another alternative example, server 29 may be located within any one or more system element(s), such as lighting device 11, lighting controller 19 or sensor 12. Similarly, although FIG. 7 depicts database 31 as physically proximate server 29, this is only for simplicity and no such requirement exists. Instead, database 31 may be located physically disparate or otherwise separated from server 29 and logically accessible by server 29, for example via network 17.

Database 31 is a collection of configuration information files for use in conjunction with one or more of software configurable lighting devices 11 in premises 15 and/or similar devices 11 of the same or other users at other premises. For example, each configuration information file within database 31 includes lighting device configuration information to operate the modulator of a lighting device 11 to steer and/or shape the light output from the light source to distribute the light output from the lighting device 11 to emulate a lighting distribution of a selected one of a number of types of luminaire as discussed above relative to FIGS. 1-6B. In many of the examples of the software configurable lighting device 11, the controllable optical modulator is configured to selectively steer and/or selectively shape the light output from the source responsive to one or more control signals from the programmable controller. The distribution configuration in a configuration information file therefore will provide appropriate setting data for each controllable parameter, e.g. selective beam steering and/or selective shape.

For some examples of the software configurable lighting device 11, the controllable optical modulator is essentially a single unit coupled/configured to modulate the light output from the emission aperture of the light source. In such an example, the distribution configuration in a configuration information file provides setting(s) appropriate for the one optical spatial modulator. In other examples of the software configurable lighting device 11, the controllable optical modulator has sub units or pixels that are individually controllable at a pixel level for individually/independently modulating different portions of the light emission from the overall output aperture of the light source. In such an example, the distribution configuration in a configuration information file provides setting(s) appropriate for each pixel of the pixel-level controllable spatial modulator.

Although a configuration information file could provide other information, the examples discussed in detail herein concentrate on implementations of the software configurable lighting device 11 using a non-imaging type light source and a modulator configuration providing a selected general lighting type distribution.

In examples for devices utilizing a non-imaging type light source, the configuration information file need not include any image-related information for driving the source. In many cases, however, the configuration information file may include values for source performance parameter settings, e.g. for maximum or minimum intensity, dimming characteristics, and/or color characteristics such as color temperature, color rending index, R9 value, etc. The configuration information file will also specify light distribution modulation that is to be implemented by the spatial modulator of the software configurable lighting device 11 to emulate a desired luminaire distribution.

The software configurable lighting device 11 is configured to set modulation parameters for the spatial modulator and possibly to set light generation parameters of the light source, in accordance with a selected configuration information file. That is, a selected configuration information file from the database 31 enables software configurable a lighting device 11 to achieve a performance corresponding to a selected type of luminaire for a general illumination application of the particular type of luminaire. Thus, the combination of server 29 and database 31 represents a “virtual luminaire store” (VLS) 28 or a repository of available configurations that enable a software configurable lighting device 11 to selectively function like any one of a number of luminaires represented by the available configurations.

It should be noted that the output performance parameters need not always or precisely correspond optically to the emulated luminaire. For a catalog luminaire selection example, the light output parameters may represent those of one physical luminaire selected for its light characteristics whereas the distribution performance parameters may be those of a different physical luminaire or even an independently determined performance intended to achieve a desired illumination effect in area 13. The light distribution performance, for example, may conform to or approximate that of a physical luminaire or may be an artificial construct for a luminaire not ever built or offered for sale in the real world.

It should also be noted that, while various examples describe loading a single configuration information file onto a software configurable lighting device 11, this is only for simplicity. Lighting device 11 may receive one, two or more configuration information files and each received file may be stored within lighting device 11. In such a situation, a software configurable lighting device 11 may, at various times, operate in accordance with configuration information in any selected one of multiple stored files, e.g. operate in accordance with first configuration information during daylight hours and in accordance with second configuration information during nighttime hours or in accordance with different file selections from a user operator at different times. Alternatively, a software configurable lighting device 11 may only store a single configuration information file. In this single file alternative situation, the software configurable lighting device 11 may still operate in accordance with various different configuration information, but only after receipt of a corresponding configuration information file which replaces any previously received file(s).

An example of an overall methodology will be described later with respect to FIG. 8. Different components in a system 10 like that of FIG. 7 will implement methods with or portions of the overall methodology, albeit from somewhat different perspectives. It may be helpful at this point to discuss, at a high level, how various elements of system 10 interact to allow a lighting designer or other user to select a particular image and performance parameters to be sent to software configurable lighting device 11.

In one example, the user utilizes mobile device 25 or laptop 27 to access virtual luminaire store 28 provided on/by server 29 and database 31. Although the examples reference mobile device 25/laptop 27, this is only for simplicity and such access may be via LD controller 19 or any other appropriate user terminal device. Virtual luminaire store 28 provides, for example, a list or other indication of physical or virtual luminaires that may be emulated either by software configurable lighting devices 11 generally and/or by a particular software configurable lighting device 11. Virtual luminaire store 28 also provides, for example, a list or other indication of potential performance parameters under which software configurable lighting devices generally and/or lighting device 11 particularly may operate. Alternatively, or in addition, virtual luminaire store 28 may allow the user to provide a customized modulation and/or light performance parameters as part of the browsing/selection process. As part of the browsing/selection process, the user, for example, may identify the particular software configurable lighting device 11 or otherwise indicate a particular type of software configurable lighting device for which a subsequent selection relates. In turn, virtual luminaire store 28, for example, may limit what is provided to the user device (e.g., the user is only presented with performance parameters for luminaire emulations supportable by to the particular software configurable lighting device 11). The user, as part of the browsing/selection process, selects desired performance parameters to be sent to a particular software configurable lighting device 11. Based on the user selection, server 29 transmits a configuration information file containing configuration information corresponding to the selected parameters to the particular software configurable lighting device 11.

It may also be helpful to discuss, at a high level, how a software configurable lighting device 11 interacts with other elements of system 10 to receive a file containing configuration information and how the software configurable lighting device 11 utilizes the received file to operate in accordance with performance parameters specified by the lighting device configuration information from the file. In a method example from the device-centric perspective, the software configurable lighting device 11 receives a configuration information file via network 17, such as the configuration information file transmitted by server 29 in the previous example. The received configuration information file includes, for example, data to set the light output parameters of software configurable lighting device 11 with respect to spatial modulation and possibly with respect to light intensity, light color characteristic and the like. Lighting device 11 stores the received configuration file, e.g. in a memory of lighting device 11. In this further example, the software configurable lighting device 11 sets light output parameters in accordance with the data included in the configuration information file. In this way, lighting device 11 stores the received file and can utilize configuration information contained in the file control the light output distribution performance of software configurable lighting device 11 and possibly light output characteristics of the device 11.

The lighting device configuration information in a configuration file may correspond to performance of an actual physical luminaire, e.g. so that the software configurable lighting device 11 presents an illumination output for a general lighting application having a distribution and possibly light characteristics (e.g. intensity and color characteristic) approximating those of a particular physical lighting device of one manufacturer. The on-line store implemented by server 29 and database 31 in the example of FIG. 7 therefore would present content showing and/or describing a virtual luminaire approximating the performance of the physical lighting device. In that regard, the store may operate much like the manufacturer's on-line catalog for regular lighting devices allowing the user to browse through a catalog of virtual luminaire performance characteristics, many of which represent corresponding physical devices. However, virtual luminaire store 28 may similarly offer content about and ultimately deliver information defining the visible performances of other virtual luminaires, e.g. physical lighting devices of different manufacturers, or of lighting devices not actually available as physical hardware products, or even performance capabilities that do not emulate otherwise conventional lighting devices.

Virtual luminaire store 28 allows a lighting designer or other user to select from any such available luminaire performance for a particular luminaire application of interest. Virtual luminaire store 28 may also offer interactive on-line tools to customize any available luminaire performance and/or interactive on-line tools to build an entirely new luminaire performance for implementation via a software configurable lighting device 11.

The preceding examples focused on selection of one set of lighting device configuration information, for the luminaire performance characteristics. Similar procedures via virtual luminaire store 28 will enable selection and installation of one or more additional sets of lighting device configuration information, e.g. for use at different times or for user selection at the premises (when the space is used in different ways).

FIG. 8 is a Ping-Pong chart type signal flow diagram, of an example of a procedure for loading lighting device configuration information to a software configurable lighting device 11, in a system like that of FIG. 7. In an initial step S1, a user browses virtual luminaire store 28. For example, a user utilizes mobile device 25 to access server 29 and reviews various luminaires or luminaire performances available in the virtual luminaire store, as represented by configuration information files of the type described above. Although mobile device 25 is referenced for simplicity in some examples, such access may be achieved by the user via laptop 27, LD controller 19 or other user terminal device. If the device 11 has appropriate user input sensing capability, access to store 28 may alternatively use device 11. In step S2, virtual luminaire store 28 presents information about available virtual luminaires to the user. The content may be any suitable format of multimedia information about the virtual luminaires and the performance characteristics, e.g., text, image, video or audio. While steps S1 and S2 are depicted as individual steps in FIG. 8, no such requirement exists and this is only for simplicity. Alternatively, or in addition, steps S1 and S2 may involve an iterative process wherein the user browses a series of categories and/or sub-categories and virtual luminaire store 28 provides the content of each category and/or sub-category to the user. That is, steps Si and S2 represent the ability of a user to review data about some number of virtual luminaires available in virtual luminaire store 28 for configuring a software configurable lighting device.

In step S3, the user identifies a particular software configurable lighting device 11 for which a selected configuration information file is to be provided. For example, if the space or area 13 to be illuminated is the user's office, the user identifies one of several lighting devices 11 located in the ceiling or on a wall of that office. In step S4, server 29 queries the particular lighting device 11 through the network(s) to determine a device type, and the particular lighting device 11 responds with the corresponding device type identification.

In one system example of multiple devices, the software configurable lighting devices 11 include 3 different types of lighting devices. Each different lighting device, for example, utilizes a different spatial distribution system 111, possibly a different type of light source 110, and a different associated driver system 113. In such an overall example, each of the 3 different types of lighting devices 11 may only be configured to provide performance for some number of available virtual luminaire performance characteristics (e.g., different virtual luminaire output distributions and possibly different virtual luminaire output light parameters, such as intensity and color characteristics). In a three-device-type example, assume device type 1 supports x sets of virtual luminaire performance characteristics, device type 2 supports y sets of virtual luminaire performance characteristics and device type 2 supports z sets of virtual luminaire performance characteristics. Thus, in this example, server 29 queries lighting device 11 in step S4 and lighting device 11, in step S5, responds with device type 1, for example.

In step S6, server 29 queries database 31 to identify available sets of virtual luminaire performance characteristics supported by the particular lighting device 11. Such query includes, for example, the device type of the particular lighting device 11. In step S7, the database responds with available sets of virtual luminaire performance characteristics supported by the particular lighting device 11. For example, if particular lighting device 11 is of device type 1, then database 31, in step S7, responds with device type 1 available sets of virtual luminaire performance characteristics. In step S8, server 29 provides corresponding information to the user about those available sets of virtual luminaire performance characteristics supported by particular lighting device 11.

Thus, steps S3-S8 allow a user to be presented with information about performance parameter sets for only those virtual luminaires supported by the particular software configurable lighting device 11 that the user is attempting to configure. However, these steps are not the only way for identifying only those sets of virtual luminaire performance characteristics supported by a particular lighting device. In an alternative example, the user may identify the device type as part of step S3, in which case, server 29 may proceed directly to step S6 without performing steps S4-S5.

In still another example, the user may identify the particular software configurable lighting device 11, either with or without a device type, in an initial step (e.g., perform step S3 before step S1). In this way, steps S1 and S2 only include information about performance parameter sets for those available virtual luminaires supported by the identified lighting device 11; and step S8 need not be performed as a separate step. In other words, steps S1-S8 represent only one example of how information describing available virtual luminaires in virtual luminaire store 28 are presented to a user for subsequent selection.

The user, in step S9, utilizes mobile device 25 to select information about a performance parameter set for a desired virtual luminaire lighting application from among the available virtual luminaire performance characteristics previously presented. For example, if the user desires a luminaire performance from device 11 analogous to performance of a particular can light for downlighting, and the performance for the desired can downlight is supported by lighting device 11, the user selects the virtual luminaire performance characteristics for the desired can downlight in step S9.

While the descriptions of various examples most commonly refer to information about a single virtual luminaire or selection of information about a single virtual luminaire, this is only for simplicity. The virtual luminaire store described herein allows a user to separately select distribution for luminaire emulation by a software configurable lighting device and the set of performance parameters to control illumination produced by that software configurable lighting device 11. As such, although not explicitly depicted in FIG. 8 or described above in relation to steps S1-S9, the user, for example, may select some of the performance characteristics for a desired first virtual luminaire lighting application corresponding to one type of luminaire, e.g. intensity and light color characteristics and select other performance parameters corresponding to a different virtual luminaire, e.g. shape and/or steering for beam light output distribution, as part of step S9. Alternatively, or in addition, the virtual luminaire store 28 may also allow the user to define or otherwise customize the set of performance parameters to be delivered to the software configurable lighting device 11.

In step S10, server 29 requests the corresponding information about the selected set of performance parameters from database 31 in order to obtain a corresponding configuration information file. Database 31, in step S11, provides the requested information to server 29. As noted previously, a software configurable lighting device 11 may be one particular type of multiple different types of software configurable lighting devices usable in systems such as 10 and supported by the virtual luminaire store 28. The selected configuration information may be different for each different type of software configurable lighting device (e.g., a first type device 11 may support light output distribution of one format while a second type device 11 may not support the same light output distribution format, a first type device 11 may support a first set of illumination performance parameters (intensity and/or color characteristics) while a second type device 11 may support a second set of illumination performance parameters). In one example, database 31 maintains different configuration information corresponding to each different type of software configurable lighting device 11; and, as part of step S11, database 31 provides the appropriate corresponding configuration information. Alternatively, database 31 maintains common or otherwise standardized configuration information; and, after receiving the requested configuration information from database 31, server 29 may manipulate or otherwise process the received configuration information in order to obtain a configuration information file more specifically corresponding to the type of the particular lighting device 11 intended to currently receive the configuration information. In this way, server 29 obtains a file of suitable configuration information including information about the selected set of performance parameters.

Server 29, in step S12, transfers the configuration information file to the particular software configurable lighting device 11. For example, the server 29 utilizes network(s) 23 and/or network 17 to communicate the configuration information file directly to the software configurable lighting device 11. Alternatively, or in addition, the server 29 may deliver the configuration information file to a user terminal (e.g., mobile device 25 or laptop 27) and the user terminal may, in turn, deliver the file to the software configurable lighting device 11. In still another example, the server 29 transfers the configuration information file to LD controller 19 which, in turn, uploads or otherwise shares the configuration information file with the software configurable lighting device 11.

In step S13, the software configurable lighting device 11 receives the configuration information file and stores the received file in memory (e.g., storage/memory 125). Once lighting device 11 has successfully received and stored the selected configuration information file, the software configurable lighting device 11 provides an acknowledgement to server 29 in step S14. In turn, server 29 provides a confirmation of the transfer to the user via mobile device 25 in step S15. In this way, a user is able to select a desired virtual luminaire performance from a virtual luminaire store and have the corresponding configuration information file delivered to the identified lighting device 11.

While the discussion of FIG. 8 focused on delivering a single configuration information file to a single software configurable lighting device 11, this is only for simplicity. The resulting configuration information file may be delivered to one or more additional lighting devices 11 in order to implement the same configuration on the additional lighting devices. For example, a user may elect to have steps S13-S15 repeated some number of times for a corresponding number of additional software configurable lighting devices. Alternatively, or in addition, the various steps of FIG. 8 may be repeated such that different configuration information files are delivered to different software configurable lighting devices 11. As such, a single configuration information file may be delivered to some number of software configurable lighting devices while a different configuration information file is delivered to a different number of lighting devices and still another configuration information file is delivered to yet a further number of lighting devices. In this way, the virtual luminaire store 28 represents a repository of sets of virtual luminaire performance characteristics which may be selectively delivered to be utilized by one or more software configurable lighting devices 11.

Other aspects of the virtual luminaire store not shown may include accounting, billing and payment collection. For example, virtual luminaire store 28 may maintain records related to the type and/or number of configuration information files transmitted to software configurable lighting devices 11 at different premises 15 and/or owned or operated by different customers. Such records may include a count and/or identifications of different lighting devices receiving configuration information files, a count of how many times the same lighting device receives the same or a different configuration information file, a count of times each set of virtual luminaire performance characteristics is selected, as well as various other counts or other information related to selection and delivery of configuration information files. In this way, virtual luminaire store 28 may provide an accounting of how the store is being utilized.

In a further example, a value is associated with each configuration information file or each component included within the file (e.g., a value associated with each set of spatial modulation or distribution type performance parameters and/or a value associated with each set of light output performance parameters). The associated value may be the same for all configuration information files (or for each included component), or the associated value may differ for each configuration information file (or for each included component). While such associated value may be monetary in nature, the associated value may alternatively represent non-monetary compensation. In this further example, virtual luminaire store 28 is able to bill for each transmitted configuration information file (or each included component); and the operator of the store can collect payment based on a billed amount. In conjunction with the accounting described above, such billing and payment collection may also vary based on historical information (e.g., volume discount, reduced value for subsequent transmission of the same configuration information file to a different lighting device, free subsequent transmission of the same configuration information file to the same lighting device, etc.). In this way, virtual luminaire store 28 may allow an individual or organization operating the store to capitalize on the resources contained within the store.

As noted earlier, the software configurable lighting devices under consideration here can utilize a variety of technologies to implement the spatial modulators. It may be helpful to consider examples of several such technologies in somewhat more detail. In that regard, we will first consider some examples of electrowetting optics that may be used as spatial modulators in implementations of lighting devices like those described above, for example, with respect to FIGS. 1 to 5B.

Electrowetting is a fluidic phenomenon that enables changing of the configuration of a contained fluid system in response to an applied voltage. In general, application of an electric field modifies the wetting properties of a surface, typically a hydrophobic surface, in the fluid system. Examples of electrowetting optics described in detail herein and shown in several of the drawings use two immiscible fluids having different electrical properties. In at least some examples, the two fluids have different indices of refraction. One fluid may be conductive. The other fluid, typically the fluid adjacent to the hydrophobic surface, may be non-conductive. The conductive fluid may be a transparent liquid, but the other fluid may be reflective, transparent, or transmissive with a color tint. Where both liquids are transparent or transmissive, the non-conductive fluid typically exhibits a higher index of refraction than the conductive fluid. In such a transmissive optic example, changing the applied electric field changes the shape of the fluid interface surface between the two liquids and thus the refraction of the light passing through the interface surface. If the interface surface is reflective (e.g. due to reflectivity of one of the liquids or inclusion of a reflector at the fluid interface), changing the applied electric field changes the shape of the reflective interface surface and thus the steering angle of the light reflected at the interface surface. Depending on the application for the electrowetting optic, the light may enter the fluid system to pass first through either one or the other of the two liquids.

The present lighting devices 11 can use a variety of different types of electrowetting optics, for example, including various types of transmissive electrowetting optics and various types of reflective electrowetting optics.

A transmissive electrowetting optic bends or shapes light passing or transmitted through the electrowetting optic. The degree of bending or shaping varies with the angle or shape of the fluid interface surface in response to the applied electric field. Transmissive optics, for example, can take the form of a variable shaped lens, a variable shaped prism, combinations of prism and lens optics, or even a variable shaped grating formed by a wavefront across the interface surface.

By contrast, a reflective electrowetting optic reflects light, and the angular redirection and/or shaping of the reflected light varies with the angle or shape of the fluid interface surface in response to the applied electric field. The two-liquid system may be controlled like a prism, e.g. in front of a mirror surface within the optic. Alternatively, the system may be configured such that the variable shaped surface itself is reflective.

We will first consider several examples of transmissive electrowetting optics and the operations thereof.

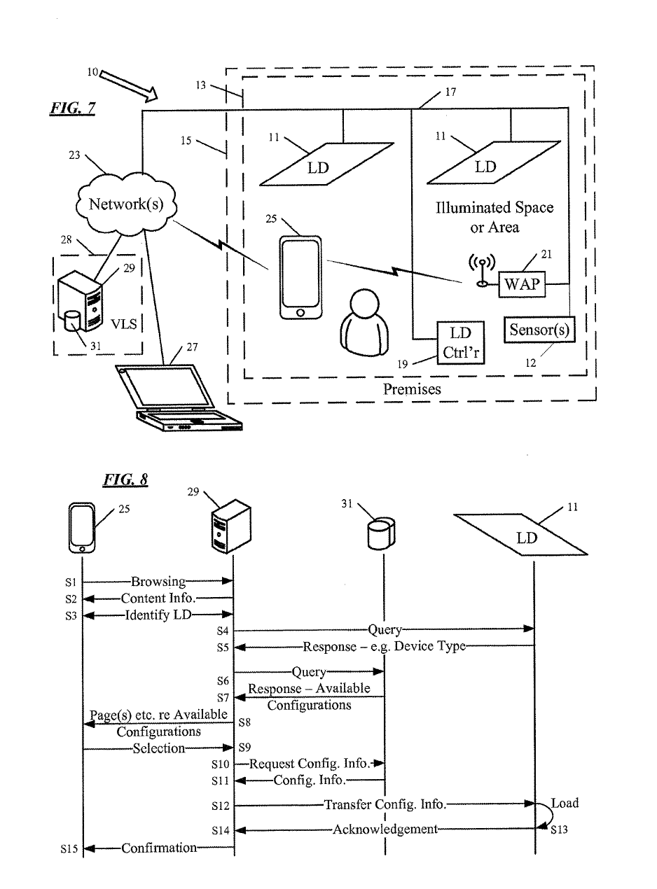

FIGS. 9A to 9D are cross-sectional views of a first example of a transmissive electrowetting type controllable optic 400, in several different states. The controllable electrowetting optic 400 in the example is controllable so as to provide variable prismatic properties to steer light as well as variable lens type properties to adjust focus and thus beam-shape of light passing through the optic 400. A controllable electrowetting optic 400 may be sized and coupled to a single or individual type of non-imaging light source, for example, as illustrated in FIGS. 2 and 3. Alternatively, a number of a controllable electrowetting optics 400 may be sized and arranged in a multi-pixel array coupled to a non-imaging light source, for example, as illustrated in FIG. 4. The ray tracings are provided to generally illustrate the beam steering and beam shaping concepts in the different state examples and are not intended to indicate actual performance of the illustrated electrically controllable liquid prism-lens optic 400.

FIGS. 9A to 9D illustrate an example of controllable electrowetting optic 400 that includes an enclosed capsule 420 and voltage sources 425 and 426. The enclosed capsule 410 is configured to contain one or more immiscible liquids (e.g., Liquid 1 and Liquid 2) that are responsive to an applied electric field based on voltages from the sources 425, 426. The drawings omit the hydrophobic surface(s), in the fluid system inside the capsule 420, for ease of illustration.

The liquids 1 and 2, for example, may be an oil and water (e.g. saline solution), respectively. Other combinations of immiscible liquids that are sufficiently transparent, have different indices of refraction and are electrically controllable may be used. In the example, liquid 1, such as an optically transmissive organic oil, has a higher index of refraction than the index of refraction of a saline water solution or the like used as liquid 2. One liquid typically is electrically conductive, and the other liquid has no conductivity for electricity. Specific fluids that may be used include aqueous solutions for the more conductive liquid, such as: aqueous mixtures of Sodium Dodecyl Sulfate (SDS), Aqueous mixtures of Potassium Chloride (KCL), and Propylene Glycol (PG); and for the non-conductive ‘oil,’ liquids such as Dow Corning OS-20, Dodecane, and silicone oil. The enclosed capsule 410, which in this example, has a physical shape of a cube or rectangular box, retains the liquids 1 and 2 to provide an electrically controllable liquid optic. Other electrowetting optic devices use enclosed capsules of different shapes.

The elements of the enclosed capsule 420 in the path of light flow through the optic 400 are formed of an appropriate transparent material, such as glass, plastic or silicone. In the transmissive prism-lens example, light enters one transmissive wall of the capsule 420, passes through the liquids and exits the optic from another transmissive wall of the capsule 420. As will be discussed more later, one form of a reflective electrowetting optic replaces or coats the second transmissive wall of the capsule 420 with a suitable reflective material. Any electrodes or leads providing connections to the electrodes formed in the optical path 400 are formed of an optically transmissive electrical conductor. Any electrode or connections not in the optical path need not be transparent and therefore may be formed of any metal or other suitable conductor.

In the example of FIGS. 9A to 9D, the enclosed capsule 420 includes terminals 427A and 427B that couple to voltage source 425C as well as terminals 427C and 427D that couple to voltage source 426. The terminals 427A and 427B are further coupled to electrodes 1 and 2, and terminals 427C and 427D are further coupled to electrodes 3 and 4. The liquids 1 and 2 respond to voltages applied to the electrodes 1-4 to provide a combination of beam steering and beam shaping functions, in this prism-lens type combined electrowetting optic. The substrate in contact with the conductive liquid (e.g., water) will always be connected to ground. For convenience, the ground electrode is not shown in FIGS. 9A to 9D, FIG. 14 and FIG. 15.

The shape of the interface surface between liquids 1 and 2 and thus the optical functionality of the optic 400 may be manipulated by adjusting the voltages applied by voltage sources 425 and 426. For example, the voltages V1 and V2 may not be equal. The voltages V1 and V2 may be applied simultaneously at different values to achieve a particular state. Although the voltages V1 and V2 are described as being applied simultaneously, the voltages V1 and V2 may be applied separately. Different values and timing of applied voltages produce different electric fields resulting in different shapes of the surface at the interface between the two liquids.

The controllable electrowetting optic 400 responds to the variable electric field created by applying different voltages from voltage sources 425 and 426 to attain the different states 1-4 illustrated by the four different examples. The states 1 and 3 provide different angular beam steering but with similar focusing beam shaping, while states 2 and 4 provide different angular beam steering but with similar defocusing beam shaping. The voltage sources 425 and 426 may apply voltages of different values including different polarities that enable the electrowetting optic 400 to provide variations of states 1-4 that may be used to process light according to different spatial modulation selections, to provide different shape and angular aspects of the output distribution of a software configurable lighting device 11. Although four states are shown, different variations of the voltages can cause the electrowetting optic to place the fluids in a variety of other states, with other shapes for the interface surface between the two liquids.

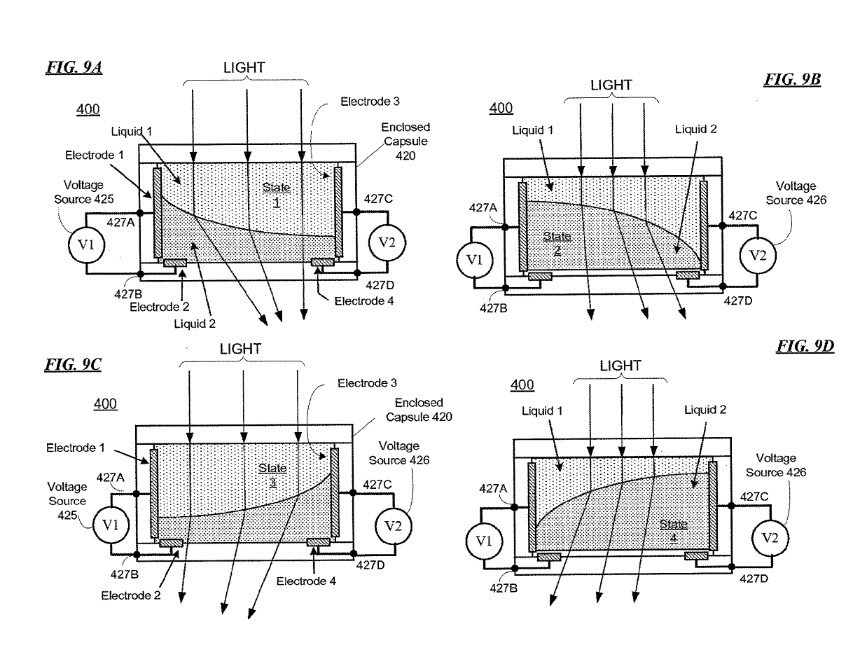

Another example of a controllable electrowetting optic 500 is shown in FIGS. 10A and 10B. The electrowetting optic 500 illustrated in FIGS. 10A and 10B is able to provide a standing wave or a moving wave configuration of the interface surface between two liquids, as illustrated in FIG. 10A. The waveform of the surface provides different degrees of refraction across the optic, for shaping and steering light passing through the optic at different locations. The waveform is produced by electric fields, and variation of the fields changes the waveform shape and thus the spatial modulation produced to different degrees across the optic 500.

The electrowetting optic 500 includes an enclosed capsule 520, which contains a liquid 7 (e.g., water) and a liquid 8 (e.g., oil), similar to the liquids discussed with regard to the earlier electrowetting example. The enclosed capsule 520 has or includes a wall that forms a substrate 525. Elements of the capsule 520 forming walls that are in the path of light passing through the optic 500, such as the substrate 520 are transparent. A reflective wall or a reflector at the interface surface may be provided to adapt the optic 500 to a reflective beam steering application, although further discussion of the example of FIGS. 10A and 10B will concentrate mainly on the illustrated transmissive implementation.

The enclosed capsule 520 also contains a hydrophobic dielectric layer 523, which also is transparent. The hydrophobic dielectric layer 523 provides a surface that repels liquids. This hydrophobic layer can be created by conformal deposition of a dielectric layer or a combination of dielectric layers using materials such as parylene, fluoropolymers, etc. These dielectric layers control the No-voltage contact angle of the liquids, and also to an extent the voltage response of the electrowetting device especially the breakdown voltage. A hydrophobic dielectric post 521 is a support member as shown in FIG. 9B, but is not shown in FIG. 9A for ease of illustration. The hydrophobic post 521 in some examples, is used to establish an initial flat film of the liquid 8 (oil) in the absence of a voltage from feedback controller 510.

The enclosed capsule 520 also includes one or more capacitance sensors 538. The capacitance sensors 538 are responsive to capacitances between the liquid water and electrodes of the array 531 and connected to provide feedback to the controller 510.

The enclosed capsule 520 also includes an array of electrodes 531 and electrode 533. The array of electrodes 531 and possibly the electrode 533 may be transparent. The array electrodes 531 and the electrode 533 are coupled to a feedback controller 510. Voltages applied to the electrodes of the array 531 (relative to the electrode 533) are individually controllable by the feedback controller 510 in response to a control signal provided by a higher level logical control element such as the microprocessor 123 of the host processor system 115 (FIG. 1). The feedback controller 510 in response to signals from the capacitance sensors 538 manipulates the voltages applied to the array electrodes 531 to maintain a desired standing or moving wave in liquids 7 and 8.

In an example, an initial high voltage is applied by the feedback controller 510 at a specific electrode in the array electrodes 531 to dewet the liquid 8 (oil) so that the oil begins to rise away from the hydrophobic layer 523. However, before the oil completely dewets the hydrophobic dielectric layer 523, which is determined based on the capacitance between the water and electrode according to measurements by the capacitance sensor 538, the voltages applied to the array of electrodes 531 are switched back to a lower voltage to undewet the hydrophobic dielectric surface 523. This process is performed over multiple instances such that the thickness of liquid 8 (oil) at that particular electrode in the array of electrodes 531 will reach a substantially stable thickness at a particular electrode of the array of electrodes 531. As a result, a standing wave lens and/or prism structure may be achieved. In another example, a moving wave structure may be achieved by dynamically controlling the voltage to the patterned electrodes of the array of electrodes 531.

It should be noted that the geometry of the oil/water interface surface is not limited to prism shapes like that shown in FIG. 10A. The lens or prism geometries provided by waveform selection could be any combination of vertically oriented convex and concave oil geometries as long as there are adequate electrodes, the aspect ratio is not too great, and control signals provided to the feedback controller 510 provide the selected waveform for a desired optical spatial modulation.

It is also envisioned that prism or lens geometries may be created that will move horizontally (e.g., left to right through the enclosed capsule 520) with time. For example, voltages at a particular frequency and timing may be applied to individual electrodes of the array electrodes 531 to generate standing waves in a time sequence, such that the standing waves appear as a constant geometry.

FIG. 10B illustrates a top-down cross-sectional view of the electrowetting optic 500 in the example of FIG. 10A. The electrowetting optic 500, as did the similar electrowetting prism-lens in the earlier example, includes transparent surfaces and electrodes that do not add significant optical processing (e.g., refraction) to the light output from the optic. As a result, the number of array electrodes 531 in electrowetting optic 500 under control of the feedback controller 510, or a processor, such as microprocessor 123 of host processor 115, may provide complex wavefronts in various locations across the optic to provide the selected spatial modulation.

The controllable electrowetting optic 500 may be sized and coupled to any of the light sources discussed above to operate as the individual of pixelated spatial modulator in any of the examples described above relative to FIGS. 1-5B.

As shown by the examples of FIGS. 9A-10B, electrowetting optics are a useful technology for implementing controllable beam steering and/or beam shaping for software configurable lighting devices. However, for lighting devices, there may be a need for relatively large beam steering angles. In a two-liquid electrowetting optic, the optical path is related to the refractive indices of liquids that are used. Typically oil and saline are used in combination for the electrowetting optic, however, the refractive index of oil limits the maximum deflection angle that can be achieved. In addition, a large beam steering angle requires large contact angle between oil and water, which requires higher operating voltage.

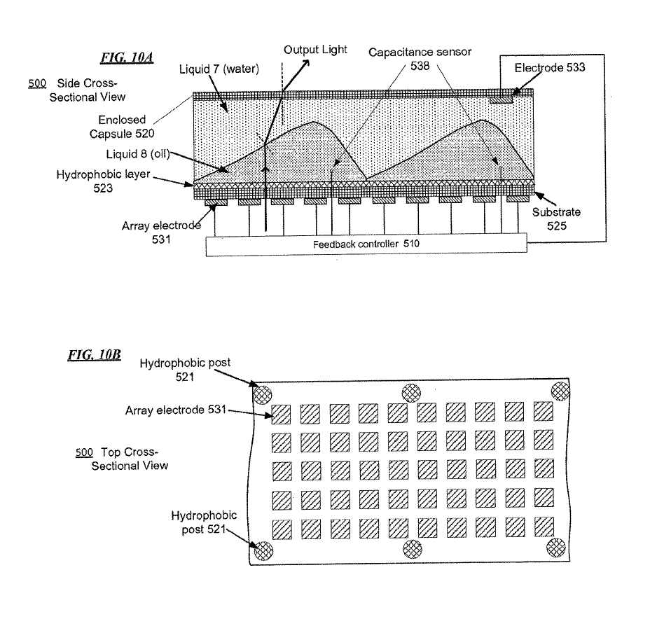

FIG. 11 represents an example of a path through the two liquids and transparent walls of a controllable electrowetting optic, illustrating the effect of the refractive indices on the beam steering angle. As shown, when light from the source passes through the input wall of the optic and hits the interface surface between the two different liquids with different refractive indices, the propagation direction of the light changes.

In the drawing, for discussion purposes, the light enters the optic from the oil side and exits the optic from the water side. The transparent walls of the capsule are omitted, and for convenience we assume that the light enters one liquid from air and exists the other liquid into air.

The index of refraction of oil is n, and the index of refraction of water nw is 1.33. θ1 is the angle of the liquid interface surface relative to the planes of the input and output surfaces of the optic. Since light enters the optic perpendicular to the plane of the input surface optic in our simple example, θ1 also corresponds to an angle of incidence of the light relative to a line perpendicular to the liquid interface surface. Then, α represents the angle of refraction relative to the line perpendicular to the liquid interface surface, after the light ray passes through and is refracted at the liquid interface surface.

The angle β is the angle of incidence of the light ray as it hits the output surface of the optic, relative to a line perpendicular to the output surface of the optic, in this simple example, where there is an interface between the water and air. Air has an index of refraction of approximately 1. The angle θ2 is the angle of refraction relative to the line perpendicular to the water-to-air interface at the output of the electrowetting optic.

The propagation angles follow Snell's law. According to Snell's law, for a given input angle, refractive index of materials the light passes through, we calculate the light output angle using the following equations:

n*sin θ1=33* sin α

β=α−θ1

1.3*sin β=sin θ2

Combing the above three equations produces the calculation:

$$θ 2 = arcsin \{ 1.33 * sin [ arcsin ( n * \frac{sin θ 1}{1.33} ) - θ 1 ] \}$$

From this equation, we see that to increase the beam deflection angle at the output of the controllable electrowetting optic it would be beneficial to increase the index n of refraction of the oil. Increased beam deflection due to the increased index of refraction of the oil also allows for use of lower control voltages to achieve a given beam steering angle.

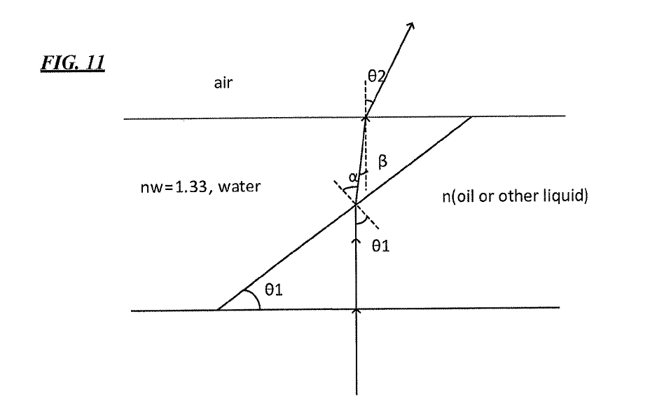

FIG. 12 shows the relationship between light output angle and contact angle between water and oil with different refractive index, the input angle is fixed to normal input. As shown, when the refractive index of oil increases, the light output angle increases with fixed contact angle, and the optic can achieve a higher maximum steering angle. This means, a higher refractive index of the oil in the optic could lead to smaller contact angle (which means lower operating voltage) with higher light output angle, and the maximum light output angle is also increased.

One approach to raise the refractive index of the oil involves adding higher refractive index particles in suspension in the oil, in appropriate concentration. ZrO2 nanoparticles have a high refractive index and high transparency with respect to visible light. Hence, addition of ZrO2 nanoparticles to the oil would increase the refractive index of the oil in the controllable electrowetting optic.

The ZrO2 nanoparticles will be in suspension in the oil. To mitigate possible sedimentation of the ZrO2 nanoparticles in the oil, the ZrO2 nanoparticles are coated with a suitable ligand to increase the colloidal stability. A variety of materials may be used as the ligand coatings, such as carboxylic group(s)-containing compounds, such as R—COOH, polymer materials, such as poly(ethylene oxides). Typically, the ligand material will exhibit properties similar to the liquid media, in this case the oil, and will tend to chemically bind the surface of the inorganic nanoparticles.

The ligand coated nanoparticles can be mixed in the oil in any of the controllable electrowetting optic examples, including the transmissive optics discussed above as well as the examples of reflective electrowetting optics discussed below.

As noted, the present software configurable lighting devices may use reflective implementations of a controllable electrowetting optic as the optical spatial modulator. It may be helpful now to consider a few examples of reflective electrowetting implementations

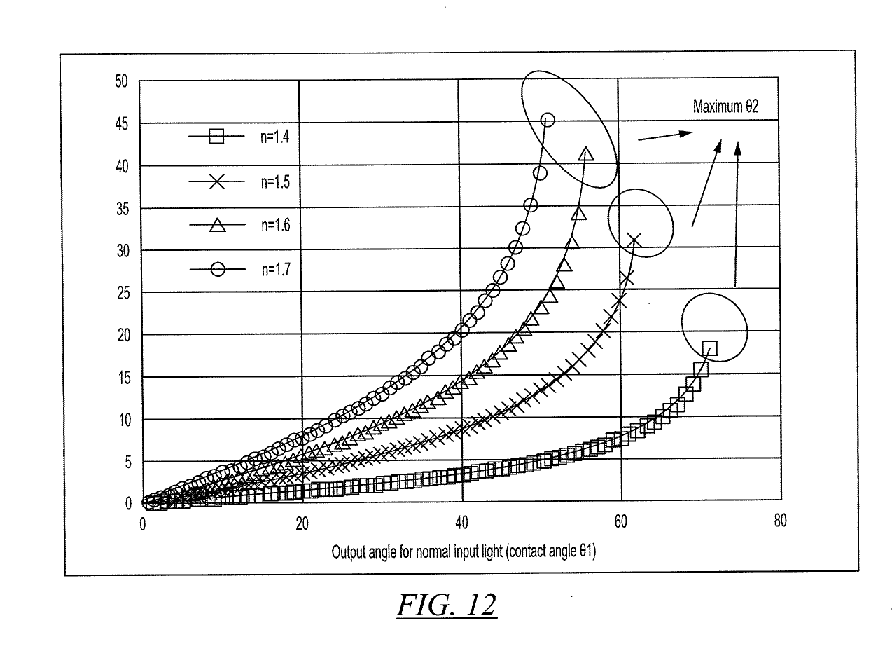

FIG. 13 depicts the light sources and spatial modulator of another example of a software configurable lighting device. In this example, the device 600 utilizes reflective electrowetting type controllable optics at cells or pixels of an array forming the spatial modulator.

The source may be any of the sources described earlier. In the example of FIG. 13, the device 600 includes light source and collimation optics shown as a combined system at 601. The system 601 may include one or more source emitters 603, each of which is coupled to a collimator optic 605. Each source 603 and associated collimator optic 605 may be implemented in a manner similar to the source and collimator in the earlier example of FIG. 3. The device 600 includes an optical spatial modulator, in the form of a pixel controllable spatial light distribution optical array 611. The pixel cells of array 611 may be or may be combined with reflective electrowetting lenses; but in the example, the pixel cells are independently controllable electrowetting prism cells, one of which is referenced by numeral 615.

In FIG. 13, the collimated light source system 610 is located beneath the reflective electrowetting prism implementation of the array 611, for purposes of example only. The number of light sources/collimators in the system 601 does not need to be the same as the number of electrowetting prism cell pixels 615 in the modulator array 611. One source/collimator, for example, could be aligned with several electrowetting prism cells 615.

In a device like that of FIG. 13, light output of the collimated light source collectively shown at 601 could be divided into different solid angle zones. For example, if the full angle of light output from collimated light source(s) at 601 is from approximately −30° to +30° relative to the system vertical axis in the drawing, that light output range could be divided into 10 solid angle zones each with an angular interval of 6°, as approximately shown in the drawing. Similar light output angular range and interval division could be implemented in the plane perpendicular to the illustration, e.g. for a device 600 utilizing a square configuration of the pixel controllable spatial light distribution optical array 611. Although one prism cell 615 is shown for each zone in the drawing, for convenience; there may be one, two or more prism cell 615 located to receive and reflect light from within each zone.

Each prism cell 615 includes a reflective surface. As shown in examples in later drawings, the reflective surface of a prism cell may be on an interior surface of the cell, typically a surface opposite the direction/surface from which the light enters the cell from the source. Alternatively, other later examples show that the reflective surface of a prism cell may take the form of a reflector at the interface surface of the two liquids in the cell. In the orientation shown by way of example in FIG. 13, a reflector may be coated on a topside surface within the prism cell or floating at the interface of two liquids in prism cell, to receive light from the source at 601 below the array 611.

For purposes of our example, the drawing shows an arrangement in which each zone of output light of the source at 601 aligns with a prism cell 615; in which case, the incident light from the aligned angular interval output zone of the light source at 601 will be reflected by the respective prism cell 615, due to the reflector included within the respective prism cell 615. By independently controlling each electrowetting prism cell 615, the incident light from the respective zone is reflected to an individually specified angle suitable for contribution to a desired overall illumination light output distribution for the device 600, similar to control of pixels or cells in earlier modulator array examples.

The size of the light source and collimation optics 601, the distance between the source and collimation optics 601 and the pixel controllable spatial light distribution optical array 611, the collimation angle, the angle of orientation of the array 611 relative to the source and optics 601, and/or the number of divided light zones from system 601 can be chosen as part of the design of the device 600 for a particular range of application in a manner to minimize the light being blocked by the source and optics 601 when reflected back by the cells 615 of the array 611. If the distance between the array 611 and the source and optics system 601 is large enough, then another approach to mitigate blockage of reflected light involves independently controlling each respective prism cell 615 so that the reflected light angle from that prism cell achieves desired beam steering within a range of angles that avoids hitting the source and optics system 601, as shown in the drawing.

The prism cells described by way of example relative to device 600 provide selective angular beam steering, by selective control of the angle of reflection produced by control of each reflective electrowetting prism cell 615. In an array 611 of cells 615 like that shown, selective beam steering of the light reflected by the prism cells can provide both steering and shaping of the overall illumination light output distribution of the device 600. To the extent any distribution beam shaping is desired for an illumination distribution for a particular selected luminaire application, each prism cell 615 can be controlled independently to provide an appropriate contribution to the desired shaping. This use of steering within an array allows use of prism cells, without also requiring a lens functionality or other type of shaping capabilities in the cells, and thereby reduces the complexity of the electrodes design and control of the cells of the spatial modulator array 611.

As a further alternative, the light source could be implemented at a location not necessarily beneath or directly in front of the electrowetting array optics in the array 611. For example, such an alternative source arrangement might use an edge light waveguide and emitter(s) coupled to the appropriate edge(s) of the waveguide.

Edge surfaces of the waveguide may be configured to allow entry of light from the emitter/sources but reflect all other light to minimize loss of light via the edges. In such a waveguide, light hitting other waveguide walls at relatively shallow angles relative to the walls is reflected and stays within the waveguide; whereas light hitting those waveguide walls at relatively large angles relative to the walls passes through the walls. A non-edge surface of the waveguide would face prism cells 615 of the electrowetting implementation of the array 611. An opposite surface would face away from the array 611 toward an area or region to be illuminated by light reflected by the array 611 in the waveguide example of the device 600.

The waveguide transfers light received via the edge to the surface facing the electrowetting array 611 within a collimated angle of output from that waveguide surface. In this example, that waveguide surface would couple light within a collimated angle to the cells 615 of the array 611. The reflected light from the prism cells 615 of the electrowetting implementation of the array 611 would pass back through the facing surface of the waveguide to the opposite surface of the waveguide, and pass through the opposite waveguide surface at the prism cell-reflected angles, without too much influence due to the angle difference. Examples for such configurations include volume holographic gratings, refractive and reflective microstructures such as prisms and mirrors, either optically coupled to or embedded directly in the waveguide to redirect the light to the electrowetting array. Also in another implementation, the electrowetting array 611 could be directly optically coupled to the waveguide with the reflective surface facing the waveguide.

As in earlier examples, the steering via control of the reflective prism cells 615 in the array 610 provides selectively configurable output distribution of the device 600. The source and collimation optics system 601 represents a combined non-imaging source, from the perspective of the spatial modulator provided by the pixel controllable spatial light distribution optical array 611. Also, the modulated light output via the pixel controllable spatial light distribution optical array 611, which provides the configured illumination distribution.

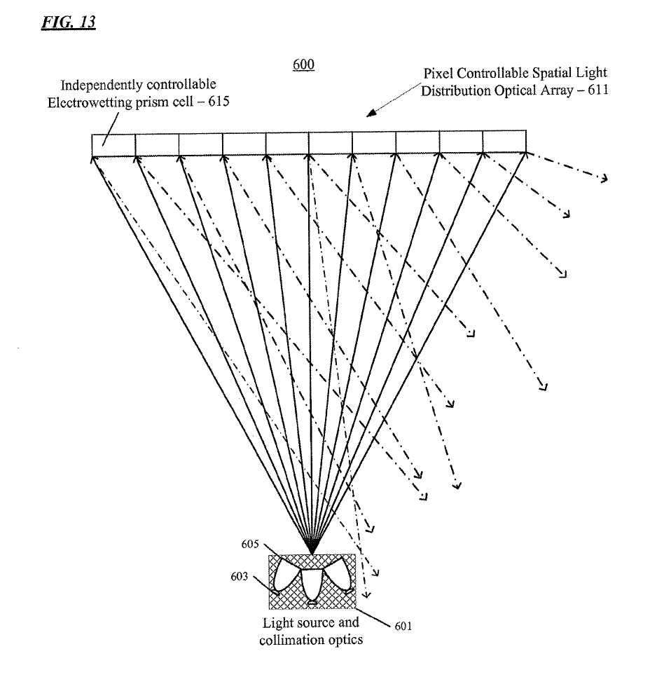

FIGS. 14A and 14B are cross-sectional views of a reflective electrowetting prism type controllable optic, which may be used in the modulator in the example of FIG. 13. More specifically, FIGS. 14A and 14B illustrate two states of reflective beam steering in an electrically controllable liquid prism cell 700A type optic, such as might form one of the cells 615 in the example of FIG. 13. The example of a prism cell 700A includes an enclosed capsule 710 enclosing two immiscible liquids (Liquid 1 and Liquid 2), which may be similar to the fluids used in the transmissive electrowetting examples discussed earlier.

Unlike the earlier electrowetting examples, however, the prism cell 700A includes a reflector. The reflector may be a coating on an appropriate interior surface of the capsule 710, such as the top interior surface in the illustrated orientation. Alternatively, the reflector may be formed at the interface between the two liquids a shown at 705 in FIGS. 14A and 14B. In an example like that shown, the reflector 705 may be formed of a mirror coating on an appropriate flexible or rigid substrate material, such as an Enhanced Specular Reflector (ESR) Film say 25 micron thick and having 98% reflectivity or an Aluminum coated Mylar Film. Alternatively, the reflector 705 may take the form of a layer of reflective particles, such as micromirror nanoparticles sometimes referred to as Janus tiles, on the surface of the oil serving as liquid 1. Other suitable reflectors may be used.

The ray tracings (arrows and references to Light—In and Light—Out) are provided to generally illustrate the beam steering concepts for the two state examples and are not intended to indicate actual performance of the illustrated electrically controllable liquid prism 700A. With the reflector 705 formed at the liquid interface, the relative indices of refraction are less significant than in the transmissive electrowetting examples discussed earlier. Light may enter the optic from the direction entering liquid 2 first, as shown; or light may enter the optic from the direction entering liquid 1 first. The wall of the enclosed capsule 710 for light to enter the appropriate liquid is transparent, whereas the opposite way of the capsule 710 need not be transparent in this reflective implementation.

The enclosed capsule 710 may have a physical shape of a cube or rectangular box. The enclosed capsule 710 retains the liquids 1 and 2 to provide an electrically controllable liquid prism supporting the reflector 705. The enclosed capsule 710 includes terminals 717A, 717B, 719A and 719B that are coupled to electrodes 1A, 2A, 3A and 4A, respectively.

The desired spatial distribution effects are provided based on changing the angle of the interface between liquid 1 having and liquid 2, to change the angular orientation of the reflector 705 relative to incoming/incident light, in response to changes in the applied electric field. This control of the angle of the reflector 705 relies on the electrowetting phenomenon to change of the configuration of the contained two-fluid system in response to an applied voltage. In general, application of an electric field modifies the wetting properties of a surface, typically a hydrophobic surface (not separately shown), in the fluid system. In this example, liquid 1, such as an oil or the like, is non-conductive. Liquid 2 such as water or a saline water solution, is relatively conductive and is transparent with respect to light in at least the visible portion of the spectrum. In the electrically controllable liquid prism 700A, changing the applied electric field changes the shape of the oil to thereby change the shape of the fluid interface surface between the two liquids. In the example, the change in the shape of the fluid interface surface changes the angle of the reflector 705 supported at that interface. Changing the reflector angle changes the steering angle of the light processed by the configurable optic 700A.

As shown in the example of FIG. 14A, the pixel prism cell 700A has a first state, State 1A, in which the voltage source 715 outputs a voltage V1 that is applied across terminals 719A and 719B and the voltage source 726 outputs a voltage V2 that is applied across terminals 717A and 717B. The voltage V1 applied to electrodes 1A and 2A and voltage V2 applied to electrodes 3A and 4A creates an electric field causing the liquids 1 and 2 to assume the State 1A, with the liquid interface surface and thus the reflector 704 in the angular orientation as shown in FIG. 14A.

In that state, input light (Light—In) is reflected to the left by the reflector 705 and is refracted at the interface from liquid 2 with the outside air at the exit surface (index of refraction lower than that of liquid 2). The light emerges back out (Light—Out) through the same wall of the enclosed capsule 710. The deflection in State 1A may represent the maximum deflection angle in the indicated direction. A range of deflection angles between the angle of State 1A and an axis perpendicular to the light/entry exit surface of the capsule 710 (e.g., zero degrees) may also be obtained by adjusting one or both of the applied voltages V1, V2 appropriately.

FIG. 14BA shows an example of the pixel cell 700A in State 2A and illustrates the output light deflection when the pixel cell 700A is in that other state. The pixel 700A achieves State 2A when a different combination of voltages V1b and V2b is applied by voltage sources 715 and 716. The different voltages create a field that causes the two-liquid system to create a different slant at the liquid interface surface and thus align the liquids 1 and 2 to assume the State 2A, with the liquid interface surface and thus the reflector 704 in the second angular orientation as shown in FIG. 14B.

In that second example state, input light (Light—In) is reflected to the right by the reflector 705 and is refracted at the interface from liquid 2 with the outside air at the exit surface. The light emerges back out (Light—Out) through the same wall of the enclosed capsule 710. A range of deflection angles between the angle of State 2A and perpendicular to the light/entry exit surface of the capsule 710 (e.g., zero degrees) may also be obtained by adjusting by adjusting one or both of the applied voltages V1b, V2b appropriately.

Hence, the angle of the deflection may be manipulated by adjusting the voltages applied by voltage sources 715 and 716. For example, the two voltages may not be equal. The two voltages may be applied simultaneously at different values to achieve a particular state between State 1A and State 2A. Although the voltages are described as being applied simultaneously, the voltage may be applied separately.

As shown by the examples of FIGS. 13-14B, beam steering may be based on an electrowetting prism mirror (EPM) type optic, and that steering at multiple pixels of an array may provide sufficient beam or distribution shaping for many lighting applications. In general, the reflector 705 in FIGS. 14A-14B is located at the oil/water interface and facing toward the incident light or at the light input of the prism cell 700. With this approach even a small contact angle of the oil/water interface could give a large beam steering angle. Conversely, reflective electrowetting could provide larger angle beam steering and beam shaping compared to transmissive electrowetting.

As noted, instead of the reflector 705 at the liquid interface, the reflector may alternatively be on the substrate of the liquid 1 side. Also, although the oil-based liquid 1 is away from the light input/output surface in the example, and the water-based liquid 2 receives the input light, that liquid arrangement may be reversed so that the light enters through the oil side. The benefit of a reflector on the substrate at the water side or oil side is easy manufacturing, but that approach may have limitations. For example, for large angle beam steering, this oil side entry alternative approach may dictate a higher incident angle at the side walls of the cell; and as a result, will always give two beams at symmetric angles, due to the total internal reflection at the side wall of each single prism cell optic in an array. Similar results can be achieved if switch oil and water, except the lobes are not at symmetric angles.

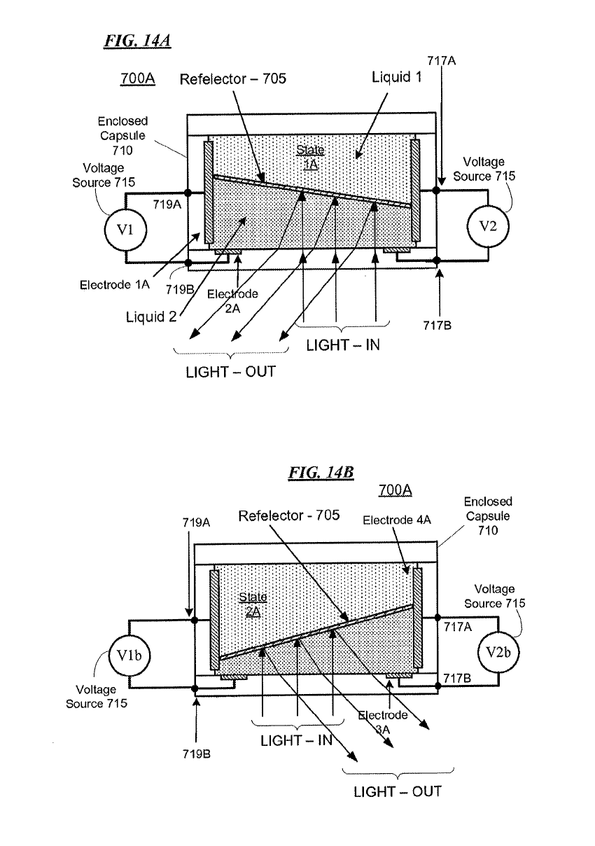

FIGS. 15A and 15B are cross-sectional views of a reflective electrowetting lens type controllable optic, in two different beam shaping states. Depending on relative size and configuration of the source and optic in a configurable lighting device, the reflective electrowetting lens 700B may serve as a spatial optical modulator across the entire output aperture of a particular source, or the reflective electrowetting lens 700B may form a pixel level configurable cell of an array type optical, spatial modulator. The reflective electrowetting lens 700B, however, provides beam shaping via variable focal characteristics of the lens, as opposed to the variable mirror angle for beam steering by the optic 700A. In general, different electric fields applied to the system produce different curved shapes of the oil and thus of the liquid interface surface of the lens formed by the oil.

The electrowetting lens mirror (ELM) type optic 700B could utilize a reflector at the interface if sufficiently flexible. The example 700B actually shown, however, utilizes a reflector 705B of an appropriate material coated or otherwise mounted on the substrate formed by the capsule wall on the oil side of the optic.

The ray tracings (arrows and references to Light—In and Light—Out) are provided in FIG. 15A and 15B to generally illustrate the beam shaping concepts and are not intended to indicate actual performance of the illustrated electrically controllable liquid lens. Light enters and exits the optic via the water side of the optic. The ELM optic 700B gives a larger beam angle, which is due to the decreased focus length of EWM. The reflective method could provide larger range for beam shaping, for example, than does a transmissive electrowetting lens.

The pixel lens cell 700B, like pixel prism cell 700A, is configured with one or more immiscible liquids (e.g., Liquid 1 and Liquid 2), which may be essentially the same as the fluids used in the various earlier electrowetting examples. Similar to the transmissive examples, the desired spatial distribution effects are provided based in part on liquid 1 having a higher index of refraction than the index of refraction of liquid 2. In this reflective example, however, the beam shaping also relies on reflection by the reflector 705B.

The ELM optic 700B includes enclosed capsule 720, constructed much like capsule 710 in the example of FIGS. 14A, 14B. In this example of FIGS. 15A and 15B, the enclosed capsule 720 may be a rectangular box, although the enclosed capsule 720 may have the physical shape of a cube, a cylinder, ovoid or the like. The enclosed capsule 720 retains liquids 1 and 2. The capsule 720 is configured with electrodes 1B and 2B that surround the periphery of the enclosed capsule 720. By surrounding the periphery of the enclosed capsule 720, voltages applied to the electrodes 1B-4B cause the liquids 1 and 2 to form a variable shaped lens that provides configurable beam shaping processing of the input light (Light—In). Terminals 737A and 737B allow voltage source 735 to be connected to the electrodes of the pixel 700B to vary the electric field applied to the liquids within the capsule 720.

As shown in FIG. 15A, the voltage source 735 applies a voltage V3 across the terminals 737A and 723B. In response to the applied voltage V3 the liquids 1 and 2 react to provide a concave shaped lens as State 1B. Input light (Light—In) from the light source (not shown) is processed by refraction through the lens shape based on control signals indicating the voltage to be applied by the voltage source 735. In this reflective example, the refracted light input is also reflected by the reflector 705 B on the back surface of the enclosed capsule 720. After reflection, light is again refracted at the interface between the two fluids. The combination of multiple refractions with reflection provides a shaped beam output, which in State 1B (FIG. 15A), focuses the light at a point the locus of which is electrically controllable. The combination of multiple refractions with reflection, however, provides a focal range with a shorter minimum focal length.

The pixel 700B is further configurable to provide beam dispersion, as shown in FIG. 15B. In that second example state, a different voltage V1b produces an electric field that causes the oil in the pixel lens cell 700B to form a convex lens, shown as State 2B. The convex lens of State 2B disperses the input light.

More specifically, the voltage source 735 applies voltage V1b across terminals 737A and 737B, which is then applied to electrodes 1B and 2B to form an electric field within the chamber of capsule 720 enclosing the two liquids. The applied electric field causes the liquids 1 and 2 to react to assume State 2B. The convex lens shape of liquid 1 in State 2B causes a dispersive refraction at the interface between the two liquids. In this reflective example, however, the refracted light input also is reflected by the reflector 705B on the back surface of the enclosed capsule 720. After reflection, light is again refracted at the interface between the two fluids. The combination of multiple refractions with reflection provides a dispersive shaped light output.

Depending upon the voltage applied by voltage source 735 to the electrodes, other states between States 1B and 2B may also be attained. With the combination of reflection and double refraction, the range between minimum focal length and maximum dispersion is larger than might be provided by a comparably sized transmissive lens using similar control voltages.

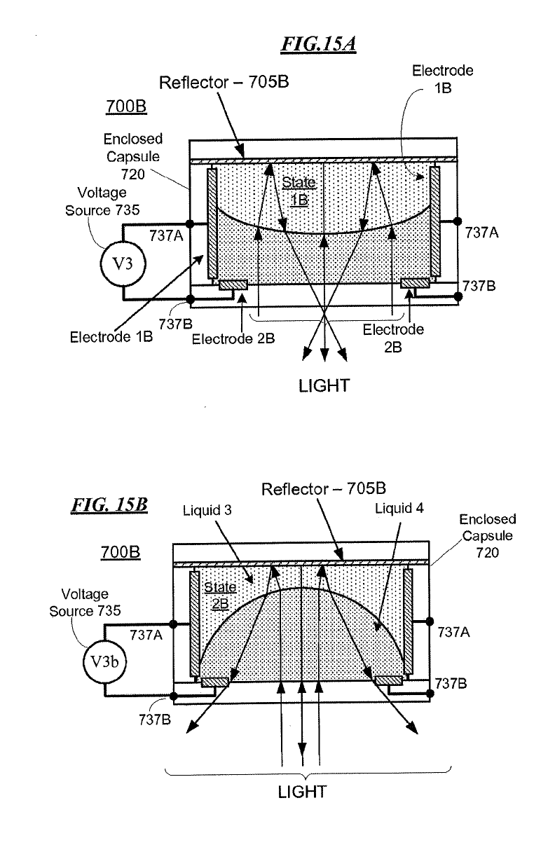

FIG. 16 illustrates a top or bottom plan view of an array 800A of controllable electrowetting optics, e.g. with an electrowetting optic cell at each ‘pixel’ of the example of the array. The pixel array 800A includes isolators and electrodes 812 that surround enclosed capsules 814. With prism cells like the shown in FIGS. 14A, 14B implementing the cells of the array 800A, the array 800A of controllable electrowetting optics may be used as the pixel controllable spatial light distribution optical array 611, in a configurable lighting device like that of FIG. 13.

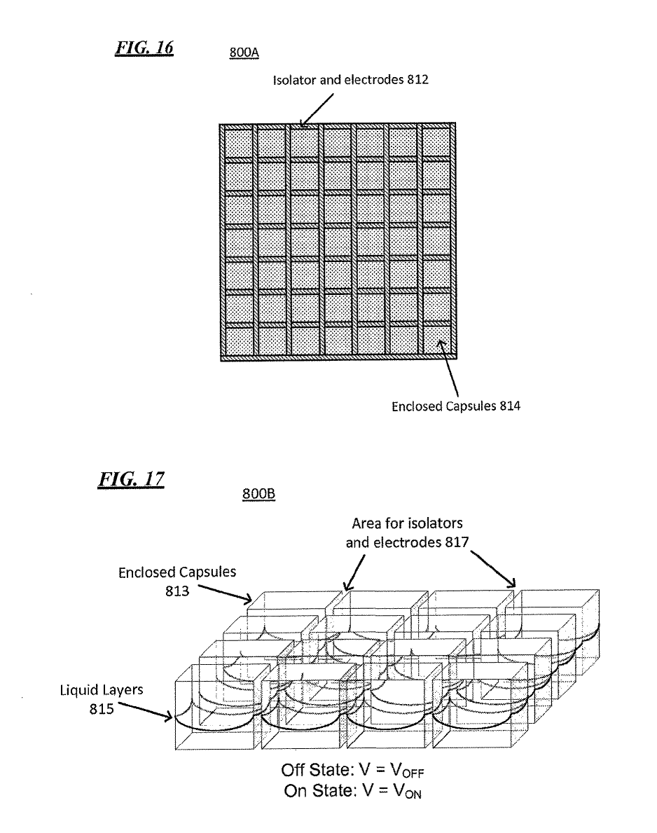

FIG. 17 is an isometric view of a number of cells of an array 800B of controllable electrowetting optics. As shown in FIG. 17, the array 800B includes a number of enclosed capsules 814, which have liquid layers 815, for example, similar to the liquids in the transmissive and reflective electrowetting examples discussed above. In the example of FIG. 17, the different pixel states, are attained by applying voltages. As shown in FIG. 17, an Off state, is achieved by an applied voltage of VOFF volts, while the On state (not shown) that corresponds to any one of the steering or shaping states described earlier is achieved by applying a voltage of VON volts. Of course, the voltages VON and VOFF may be any voltage and/or polarity, such as ±10 volts or ±10 millivolts, suitable for achieving the desired beam steering (e.g., angular modulation) or beam shaping. Said differently, the control signal may be analog so the control of the beam shaping or beam steering may extend over a range of focal lengths (e.g., narrow focused beam to wide dispersed beam) or over a range of angles (e.g., zero degrees, or straight out, from the lighting device to an angle that may be up to approximately 90 degrees from the vertical, or even greater than 90 degrees depending upon the geometry of the electrowettable lens or lighting device).

For an array of reflective electrowetting type optics, whether configured for beam shaping or beam steering, the cell shape may be square or rectangular, in order to obtain a high aspect ratio to decrease optical loss. For an array of reflective electrowetting type optics, the cell shape may be square or rectangular, although circular cell shapes also may be used.

Another approach to providing spatial modulation utilizes of micro-electrical mechanical systems (MEMS) that integrate and manipulate similarly scaled optical elements, in this case for spatial modulation of light from the source in a software configurable lighting device. Various optical MEMS technologies exist that utilize reflective optical elements, such as Digital Micro-Mirror Devices (DMD), tip/tilt/piston analog mirrors, and Interferometric Modulator Devices (IMOD)). Other optical MEMS technologies utilize transmissive optical elements, such as Digital Micro Shutter (DMS) and Micro-Optical Switch (MOS); whereas still other optical MEMS technologies utilize diffractive optical elements such as a Grating Light Valve (GLV). Similar technologies, although possibly on a smaller scale, are referred to as nano-electro-mechanical systems (NEMS). For convenience, further discussion of examples of this type will refer to MEMS, and readers should understand the similar applicability to NEMS. As such, the optical element in a MEMS/NEMS based spatial modulator can be any optical element supportable by a MEMS/NEMS mounting and controllable system, e.g. mirror, lens, prism or warpable version(s) thereof. Also, controllable motions include pan, tilt, in-out (piston like) movement and warp/twist of thin materials forming the optical elements. The following description of a MEMS device is only an example of but one MEMS implementation of a controllable optical spatial modulator, other implementations are envisioned and other MEMs devices may be used as the optical elements.

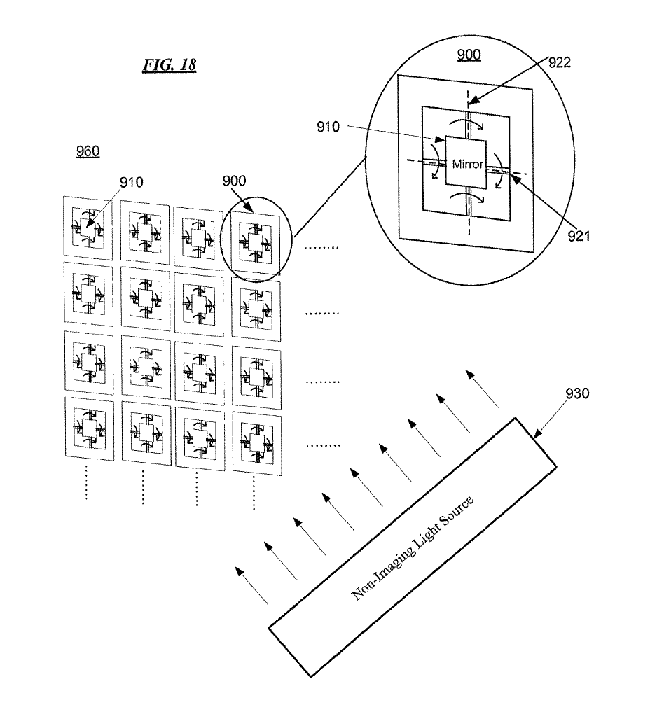

In our example (FIG. 18), a MEMS based spatial modulator 960 takes the form of a MEMS array 960 suitable for beam deflection and/or shaping. The array 960, for example, is suitable for use in a lighting device arrangement functionally like that of FIG. 4 in which a non-imaging light source 210 supplies light to a pixelated spatial modulator 211, particularly if the MEMS array uses a transmissive type of micro-optical elements. In a mirror based MEMS example like that of FIG. 18, a non-imaging light source 930 supplies light to a pixelated spatial modulator formed by the MEMS array 960 of the configurable lighting device from a somewhat different position or direction so as to facilitate illumination of a desired region or area with the reflected light, without undue blocking of reflected light by the source 930.

In the illustrated example of FIG. 18, each pixel of the array 960 includes a MEMS mirror type device 900; although, as noted earlier, other micro-scale optical elements may be used instead of the mirror. One of the pixel MEMS mirror type devices 900 is shown in an enlarged form.

As shown, the mirror 910 of the MEMS device 900 is rotatable in two (2) directions (about the X-Y axes as represented generally by dotted lines in the drawing). For example, a voltage applied to electrodes of the appropriate electromechanical actuator(s) of the MEMS (not shown) may cause rotation in a first axial direction about axis 921; and as the voltage changes, the mirror 910 may rotate a number of degrees corresponding to the changes in voltage. Similarly, voltage applied to a different set of electrodes of the appropriate electromechanical actuator(s) of the MEMS may cause the mirror 910 to rotate in a second axial direction about axis 922. Unless the mirror 910 or the connections to the mirror are sufficiently flexible or rotatable (e.g. supported by a two-axis gimbal mounting set), the rotation of the mirror 910 may be limited to rotation in a single axial direction at one time. Only after stopping to rotate in the selected axial direction, such as 921, may the mirror 910 begin to rotate in the other axial direction, which is subsequently selected.

The MEMS electromechanical elements may also allow controllable movement of the mirror 910 in the plane perpendicular to the X-Y plane, or along the Z axis (e.g., in and out) in response to an applied voltage. In other words, the MEMs device 900 may provide rotational pan and tilt movement as well as piston-like movements of the mirror 910. In such an example, the mirror 910 may be controlled to move in and out in the third axial direction after stopping rotation in either the first or second axial directions, in response to a further voltage applied to the appropriate electromechanical actuator(s) of the MEMS. In other examples, concurrent movement in two axial directions (e.g., X and Z, or Y and Z) may also be provided.

In other configurations, the MEMS mirror array 960 may provide a beam focusing functionality (e.g., by forming a convex mirror surface) over a range of angles, for example, by selectively controlling the orientation (tip and tilt movements) and location (piston movement) of the individual mirrors 910.

In a pixelated spatial modulator application, the modulator array 960 includes rows and columns of individual MEMS elements, individual MEMS mirrors 910 in our example, at the pixels located at the intersections of the rows and columns of the array 960. Each individual MEMS mirror unit 910 at a pixel of the array 960 may be individually/independently controlled to achieve the deflection angle required of a spatial modulator pixel to selectively spatially modulate an input beam from the light source 930.

Another class of beam steering and/or beam focusing system examples utilizes liquid crystal polarization grating (LCPG) optical modulation technology. For example, liquid crystal (LC) panels, polarization gratings (PG), and a combination of LC and PG may also be used to achieve the selected illumination light distribution (e.g., beam shaping and/or beam steering). In some examples, LC panels are used to change the polarization of input light, and PGs diffract light based on the polarization of the light that is input to the respective PG. PGs have a nematic LC film with a continuous periodic pattern.

Within a PG's LC film pattern, the in-plane uniaxial birefringence varies with the position of the input light along the grating period. The grating period is spacing of the liquid crystals that form the grating of the polarization grating. There are two types of PGs: a passive PG and an active PG.

A passive PG changes the handedness of circularly polarized light into an opposite state (i.e., from left handed polarization to right handed polarization and vice versa) due to the light phase shift when passing through the PG. Additionally, the light will be diffracted to either in a +1 state or a −1 state depending upon the handedness of input circularly polarized light. The diffraction angle also depends the input light wavelength and a grating periodic of PG.

An active PG is responsive to a voltage applied to electrodes connected to the PG. In some examples, when the applied voltage is zero (0) volts, the active PG responds as a passive PG as explained above. When a voltage is applied that exceeds a threshold voltage (Vth), the periodic nature of the PG is altered, and, as a result, the light polarizing and the diffractive effects on the input light are eliminated. Said differently, when a voltage over a threshold voltage is applied to the PG, the input light is not polarized and the direction of the light will not be changed after passing though the active PG. Conversely, if no voltage is applied to the active PG, the light will be diffracted to either a positive (+) 1 state (or direction) direction or in a negative (−) 1 state (or direction) depending upon the handedness of input circularly polarized light. In other words, the diffraction properties of the active PG are controlled by applying a voltage to electrodes (not shown) of the PG, that controls the amount of light distributed between the (0) direction and ±1 directions.

In the fabrication of either a passive PG or an active PG, the angle of diffraction is set when the PG is fabricated, and the angle of diffraction may be different for different wavelengths of light and for light with different polarizations. For polarized light, the angle of the diffraction is either in a +1 state (or direction) or in a −1 state (or direction), but the angle of diffraction is the same just the numerical sign and direction is different. Unpolarized light is diffracted equally into the ±1 directions by either the passive PG or the active PG.

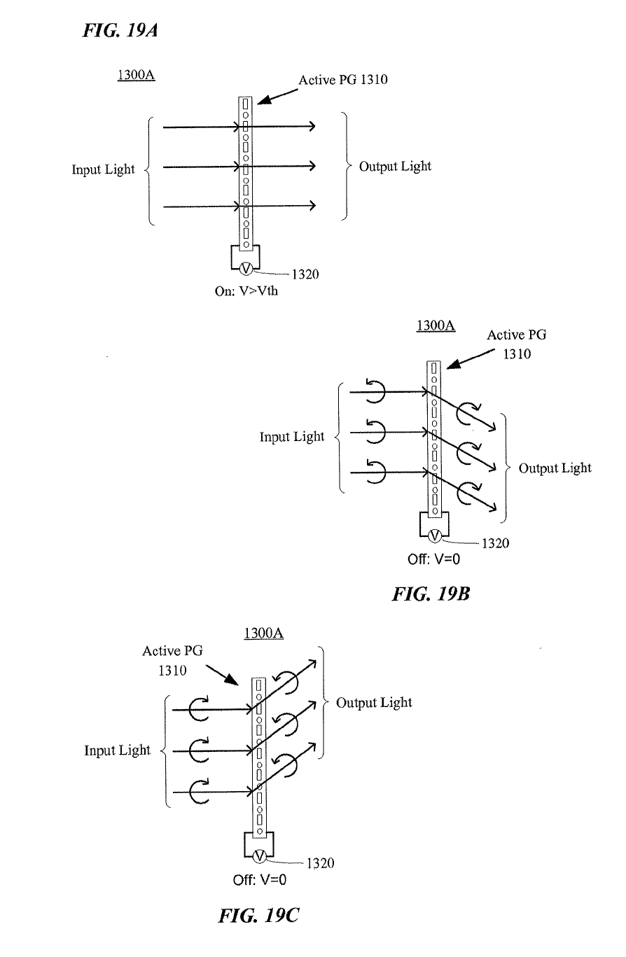

FIGS. 19A to 19C illustrate various aspects of an example of a pixel-level selectable beam steering matrix, pixelated spatial modulator 211 of a configurable lighting device (see e.g. FIG. 4). The example of FIGS. 19A to 19C uses an active, switchable PG for spatial beam modulation of generated light. Spatial beam modulation includes beam steering. FIG. 19A to 19C show an example of a system 1300 that includes an active PG 1310 and a voltage source 1320.

In FIG. 19A, the voltage source 1320 is applying a voltage greater than a threshold voltage Vth to the active PG 1310. The voltage may be applied to electrodes (not shown) in the active PG 1310. As shown in the example, when a voltage greater than threshold voltage (>Vth) is applied to the PG 1310 and polarized light is input to the active PG 1310, the input light (from a light source shown in other drawings) passes through the active PG 1310 without being diffracted or having the polarization of the input light being changed.

Alternatively, when a voltage less than the threshold voltage Vth is applied, such as a zero (0) voltage, as shown in FIG. 19B, the same active PG 1310 processes light input to the active PG 1310 in the same manner as a passive PG. In the example of FIG. 19B, the input light is left-hand (LH) circularly polarized. When the left-hand circularly polarized light is applied to active PG 1310, the output light is right-hand (RH) circularly polarized light and is diffracted at a predetermined angle Φ from the angle of incidence of the input light and in a direction that is a negative angle, or −1 state.

In the state shown in FIG. 19C, the input light is right-hand (RH) circularly polarized. When the right-hand circularly polarized light is applied to active PG 1310, the output light is diffracted, also at a predetermined angle Φ from the angle of incidence but in an opposite direction, in this example, a positive angle, or +1 state, and is left-hand (LH) circularly polarized light.

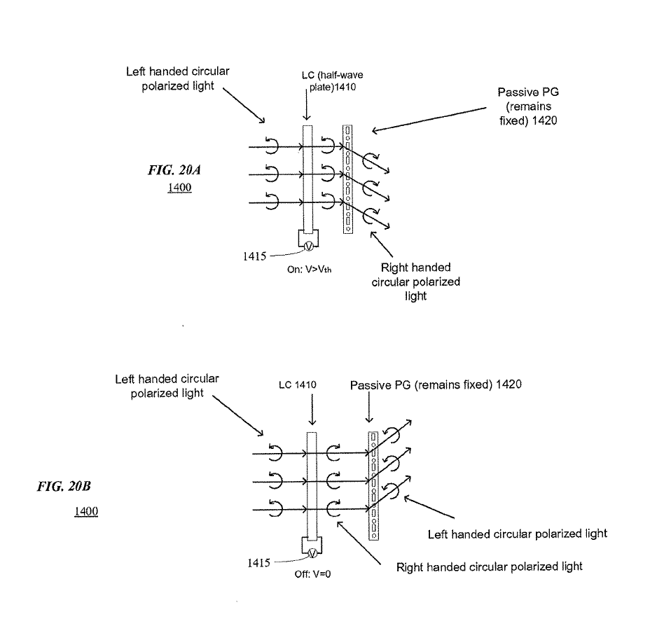

The example of FIGS. 19A-C illustrates the capabilities of active PGs with respect to different polarized lighting. As mentioned above, LC plates also may be used to process light to produce different effects. LC plates may also be active (i.e., responsive to an applied voltage); and when combined with a passive PG, the combination of LC plates and PGs provide different steered light outputs. FIGS. 20A-20D illustrate examples of the response of passive, switchable LCPGs to the application of left handed circularly polarized light and right handed circularly polarized light.

In general, when a passive PG is coupled with an active LC, the LC will change the polarization of input light if no voltage is applied to it, and the PG diffracts the light into either +1st or −1st state direction depending upon the input light polarization. By controlling the LC, the input light polarization may be controlled, which affects the diffraction order of the input light after passing through the coupled passive PG.

In the example of FIG. 20A, the system 1400 includes a LC 1410, such as a half-wave plate, and a passive PG 1420, which remains fixed. The polarization properties of the LC 1410 are controlled by applying a voltage to electrodes (not shown) coupled to the LC. A voltage source 1415, which may be responsive to a control signal, may apply a voltage V that is greater than a threshold voltage Vth. In the example of FIG. 20A, left-hand circularly polarized light is input to the LC 1410 to which the voltage source 1415 is applying a voltage greater than Vth (i.e., >Vth). Due to the applied voltage Vth, the left-hand circularly polarized light of the input light is unaffected by the LC 1410. However, when the left-hand circularly polarized light output from the LC 1410 is input to the passive PG 1420, the left-hand circularly polarized light is diffracted at some predetermined angle as a +1 order output, for example, and the polarization of the light output from the passive PG 1420 has a right-hand circular polarization.

In the example of FIG. 20B, instead of outputting a voltage greater than (>) Vth, the source 1415 outputs a zero (0) voltage (i.e., V=0) or some voltage less than (<) Vth to the LC 1410. As a result of the reduced voltage, the LC 1410 acts to switch the polarization of the input light. In the FIG. 20B example, the left-hand circularly polarized light input to the LC 1410 is output from the LC as right-hand circularly polarized light. The right-hand circularly polarized light output from the LC 1410 is input to the passive PG 1420. The passive PG 1420 diffracts the right-hand circularly polarized light to the same predetermined angle but as a −1 order output, and also changes the polarization of the inputted light from right-hand circularly polarized light to left-hand circularly polarized light.

In yet another example using the implementation of the system 1400, FIG. 20C illustrates right-hand circularly polarized light as an input to the LC 1410 when the voltage source 1415 supplies a voltage greater than Vth. Due to the applied voltage Vth, the right-hand circularly polarized light of the input light is unaffected by the LC 1410. However, when the right-hand circularly polarized light output from the LC 1410 is input to the passive PG 1420, the right-hand circularly polarized light is diffracted at some predetermined angle, for example, as a −1 state output and the polarization of the light output from the passive PG 1420 has a left-hand circular polarization. Alternatively, in the example of FIG. 20D, instead of outputting a voltage greater than (>) Vth, the voltage source 1415 supplies a zero (0) voltage (i.e., V=0) or some voltage less than (<) Vth to the LC 1410. As a result of the reduced voltage, the LC 1410 acts to switch the polarization of the input light. In the FIG. 20D example, the right-hand circularly polarized light input to the LC 1410 is output from the LC as left-hand circularly polarized light. The left-hand circularly polarized light output from the LC 1410 is input to the passive PG 1420. The passive PG 1420 diffracts the left-hand circularly polarized light to the same predetermined angle but as a +1 state output, and also changes the polarization of the inputted light from left-hand circular to right-hand circularly polarized light.

The examples of FIGS. 20A-20D may be used as the pixel-level spatial modulator elements in an array, such as in the array 211 in FIG. 4, receiving light from a non-imaging light source of one of the types discussed earlier. Also in such cases, the active LC cell used with passive PGs could be that from an off-the-shelf LCD panel with polarizers removed. Alternatively, the LCPGs of FIGS. 20A-20D may be implemented in a non-pixelated manner to process light output from a particular light source.

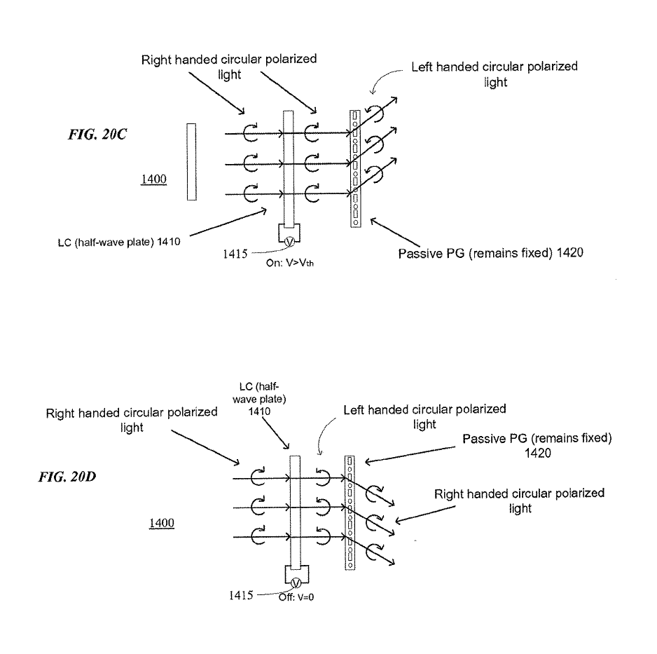

Other configurations that incorporate PGs, LCs and LCPGs are also contemplated. FIGS. 21A illustrates an example of a controllable light spatial light modulation system using polarization gratings (PG) technology for the spatial modulation.

FIG. 21A illustrates the use of two switchable PG stacks for beam steering of a single source. The combination of the light source 1510 and the spatial optical beam steering system formed by the two switchable PG stacks 1541, 1542 may form a configurable lighting device, e.g. analogous to the devices shown by FIGS. 2 and 3. Alternatively, a panel source similar to 210 in FIG. 4 might include some number of the sources 1510, in which case, an associated modulator array similar to 211 of FIG. 4 might include a number of pairs of PG stacks 1541, 1542 for each source 1510.

In FIG. 21A, unit 1500 includes the light source 1510, a lens 1520 and a passive PG 1530. The lens 1520 and passive PG 1530 couple light output from the source 1510 to a beam steering assembly 1570, which in this example, includes active PG or LCPG stacks 1541 and 1542. As shown, the beam steering assembly 1570 also includes controllable voltage sources 1551 and 1552, although the voltage sources could be implemented as separate circuit elements of a driver system associated with higher layer control logic. The unit 1500 may be implemented, for example, as an entire 2 feet by 2 feet lighting fixture or, on a smaller scale, as one pixel in an array of pixels.

The lens 1520 may be a TIR lens, a reflector lens, a microlens, or an aligned microlens film. The lens 1520 is provided to collimate unpolarized light output by the light source 1510. The passive PG 1530 is a single layer PG in this example, but, in other examples, may be a stack of PGs or LCPGs. The passive PG 1530 processes the collimated light output from the lens 1520 by separating the unpolarized light into left-hand circularly polarized light (labeled A-LH) and right hand circularly polarized light (labeled B-RH).

The configurable lighting unit 1500 provides selectable beam steering angles by using switchable, active PGs 1541 and 1542 stacked upon one another to control the beam steering angle of the light output from the system 1500. In particular, the respective active stacks 1541 and 1542 variably steer the right-hand and left-hand circularly polarized light received from the PG 1530 based on the voltage applied by the respective voltage sources 1551 and 1552. The voltage sources 1551 and 1552 may respond to control signals provided by a higher layer control element (not shown) as in the earlier lighting device examples. In addition, while the voltage sources 1551 and 1552 are shown separately, a single voltage source may be used. Similar to the discussion of FIGS. 19A-19C, the respective active stacks 1541 and 1542 are controllable to provide a range of beam steering angles, such as between ±40°. Different combinations of PGs (active and/or passive) and/or LCPGs provide different ranges of beam steering angles. In addition, the number of PGs and/or LCPGs is chosen to provide a desired beam step resolution and a maximum desired beam steering angle, which will be discussed in more detail with reference to FIG. 21B.

FIGS. 21B and 21C illustrate examples of the concept of stacking PGs in an example for controlling the beam steering angle of input light, e.g. for use in either of the active stacks 1541, 1542 of the unit 1500 of FIG. 21A.

FIG. 21B shows an active stack, such as 1541, having multiple active PGs. In a specific example, the PG beam steering assembly 1575 includes first and second active PG stacks having different beam step resolutions. For example, beam step resolution is the smallest angular displacement of an individual PG in the stack of PGs. For example, the angular displacement for active stack 1541 shown in FIG. 21A may be ±40°. Of course, ±40° is only an example, other angular displacements may be possible depending upon stacking of PG elements and/or geometry of the respective assemblies 1575 (and 1576 ). One of the PGs in the stack may permit only a 2° angular displacement. The 2° angular displacement enables the stack 1541 to step through the ±40° angular displacement in 2° intervals. Accordingly, in this example, the described stack has a beam step resolution of 2°. Multiple active PG stacks may be further stacked together to obtain the desired degree of spatial modulation for a particular non-imaging light source and the general lighting illumination application for the particular lighting device.

FIG. 21C shows an active stack 1576 having multiple LCs with passive PGs. Each combination of a LC and a PG provides one step of a switchable beam steering functionality. The step-wise beam steering is analogous to the step-wise beam steering discussed above relative to the stack 1575 of FIG. 21B, except that each LC/PG step in the stack 1576 of FIG. 21C functions like the LCPG 1400 of FIGS. 20A-20D.

Different implementations of the LCPG may be used in the beam steering assembly 1576. In a first implementation, as shown in the example in FIG. 21C, the LCPG in the beam steering assembly 1576 includes a plurality of active switchable LC half-waveplates and a plurality passive PGs interspersed with the active switchable LC half-waveplates. In a second implementation example (not shown), the LCPG in the beam steering assembly 1576 may include an LC half-wave plate and an active PG.

Alternatives to the LCPG stack examples shown and described so far include vertical-continuous optical phased arrays (V-COPA), controllable graded index (GRIN), and microlens array based on liquid crystal materials.

V-COPA is a liquid crystal based technology capable of tunable angle beam steering. In an example, patterned electrodes, such as in a checkerboard pattern, are used in combination with vertically aligned liquid crystal materials. In the V-COPA example, when no voltage is applied, the liquid crystals are vertically aligned to the substrate and the structure is optically transparent. By using high resolution patterned electrodes, when a voltage is applied, the liquid crystals can be caused to align in arbitrary patterns to provide arbitrary beam shaping and beam steering. The resolution, or number, of the electrodes needed to provide the arbitrary patterns limits the maximum achievable angle and resolution. V-COPA technology may be used in combination with a large angle approach, such as volume holograms, to provide greater steering angle ranges.

Another LCPG alternative is the controllable GRIN lens array based on liquid crystal materials. Since LCs are birefringent, the refractive index depends on the orientations of the LC in the array. Similar to the V-COPA example, the resolution, or number, of the electrodes needed to provide the arbitrary patterns for beam shaping/beam steering limits the maximum achievable angle and resolution. By applying an electric filed to the LC material, a controllable GRIN lens suitable for beam shaping may be achieved that has an index profile dependent on the arbitrary electrode pattern.

The third example of an alternate LC material solution is a microlens array based on liquid crystal (LC) materials. This approach is also based on the birefringent properties of LCs in which a voltage applied to LC-based microlens controls the beam shaping capabilities of the microlens array.

As shown by the above discussion, functions relating to communications with the software configurable lighting equipment, e.g. to select and load configuration information into such equipment, may be implemented on computers connected for data communication via the components of a packet data network, operating as the on-premises network 17 and/or as an external wide area network 23 as shown in FIG. 7. Although special purpose devices may be used, such devices also may be implemented using one or more hardware platforms intended to represent a general class of data processing device commonly used to run “server” programming so as to implement the virtual luminaire store functions at 28 and configured to operate as user terminal devices shown by way of example at 25 and 27, albeit with an appropriate network connection for data communication.

As known in the data processing and communications arts, a general-purpose computer or the like typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files 128 used for the configuration information (see FIG. 1) and the similar files maintained in the database 31 (FIG. 7). The software code of the store is executable by the general-purpose computer that functions as the virtual luminaire store server 29 and/or related client software that runs on an appropriate terminal device 25 or 27. In operation, the code is stored within the respective general-purpose computer platform. At other times, however, the software may be stored at other locations and/or transported for loading into the appropriate general-purpose computer system. Execution of such code by a processor of the computer platform enables the platform to implement relevant aspects of the methodology (e.g. appropriate steps of the flow shown in FIG. 8) for selection and installation of configuration information in a software configurable lighting device 11, in essentially the manner performed in the implementations discussed and illustrated herein. Executable software programming 127 of the lighting device 11 also may be stored on a computer and transferred via network communications for installation in a lighting device 11, e.g. as part of initial set-up of the lighting device or as an update.

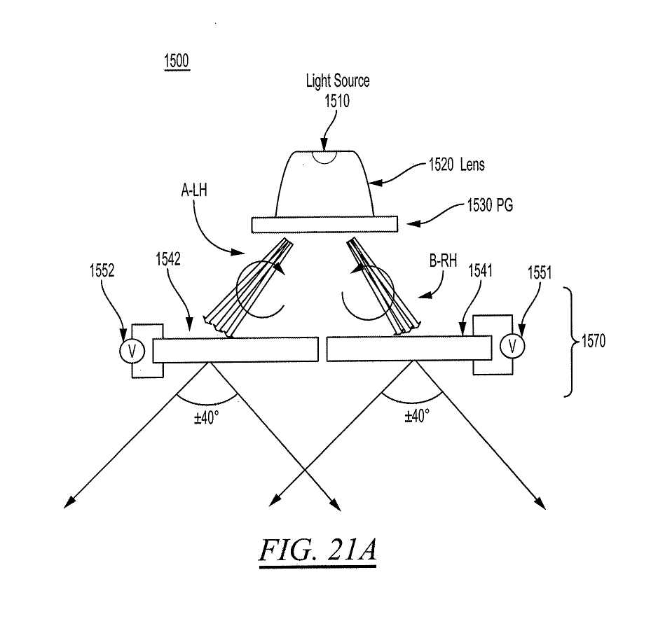

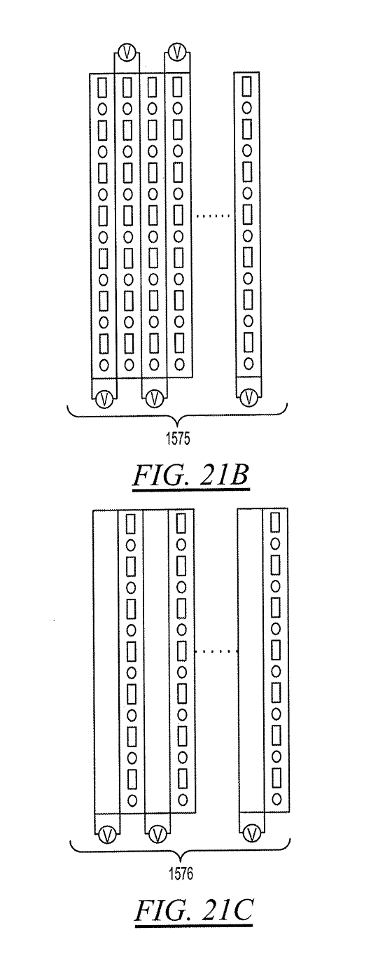

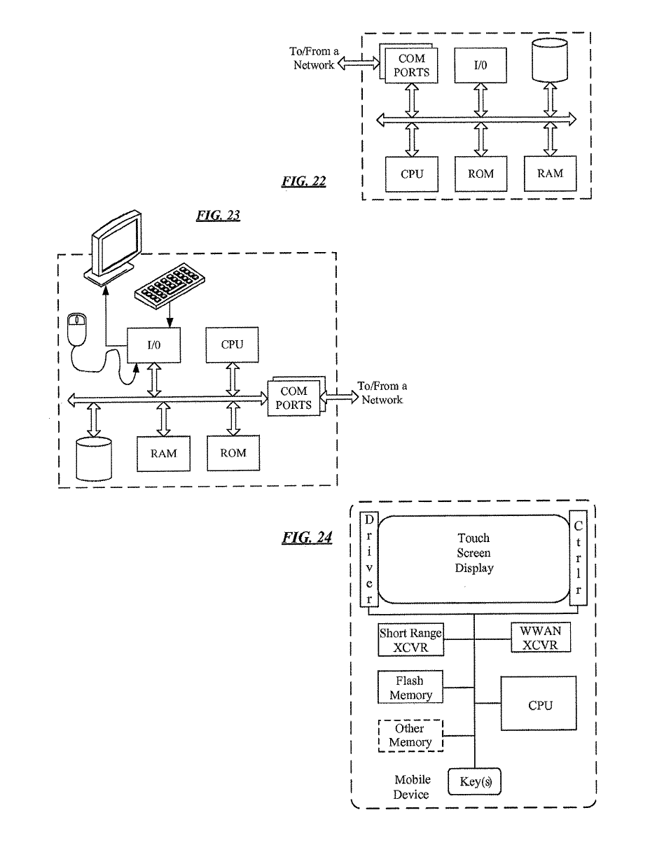

FIGS. 22 to 24 provide functional block diagram illustrations of general purpose computer hardware platforms. FIG. 22 illustrates a network or host computer platform, as may typically be used to implement a server, like the server 29. FIG. 23 depicts a computer with user interface elements, as may be used to implement a personal computer or other type of work station or terminal device similar to that shown at 27 in FIG. 24, although the computer of FIG. 23 may also act as a server if appropriately programmed. It is believed that those skilled in the art are familiar with the structure, programming and general operation of such computer equipment and as a result the drawings should be self-explanatory. FIG. 24 shows an alternative implementation of a user terminal device for client type operations, in the form of a mobile device.

A server, for example (FIG. 22), includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

A computer type user terminal device, such as a personal computer or the like, similarly includes a data communication interface CPU, main memory and one or more mass storage devices for storing user data and the various executable programs (see FIG. 23). A mobile device type user terminal (see FIG. 24) may include similar elements, but will typically use smaller components that also require less power, to facilitate implementation in a portable form factor. The various types of user terminal devices will also include various user input and output elements. A computer terminal device (see FIG. 23), for example, may include a keyboard and a cursor control/selection device such as a mouse, trackball, joystick or touchpad; and a display for visual outputs. Many newer of such terminal devices also include touchscreens. A microphone and speaker enable audio input and output. Some mobile devices include similar but smaller input and output elements. Tablets, smartphones and other types of mobile devices often utilize touch sensitive display screens, (see FIG. 24) instead of separate keyboard and cursor control elements. The hardware elements, operating systems and programming languages of such user terminal devices also are conventional in nature, and it is presumed that those skilled in the art are adequately familiar therewith.

Hence, aspects of the methods of selecting and installing configuration information in a software configurable lighting device outlined above may be embodied in programming, for a server computer, a user terminal client device and/or the software configurable lighting device. Program aspects of the technology may be thought of as “products” or “articles of manufacture” typically in the form of executable code and/or associated data (e.g. configuration information and/or files containing such information) that is carried on or embodied in a type of machine readable medium. “Storage” type media include any or all of the tangible memory of the lighting devices, computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the configuration information and/or applicable programming from one device, computer or processor into another, for example, from a management server or host computer of the store service provider into the computer platform of the server 29 and/or database 31 and/or from that store equipment into a particular configurable lighting device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software, e.g. the programming and/or data. As used herein, unless restricted to non-transitory, tangible “storage” media, terms such as computer or machine “readable medium” refer to any medium that participates in providing instructions to a processor or the like for execution or in providing data (e.g. configuration information) to a processor or the like for data processing.

Hence, a machine readable medium may take many forms, including but not limited to, a non-transitory or tangible storage medium, a carrier wave medium or physical transmission medium. Non-volatile storage media include, for example, optical or magnetic disks, such as any of the storage devices in any computer(s) or the like, such as may be used to implement the software configurable lighting device, or the store server, or the user terminals, etc. shown in the drawings. Volatile storage media include dynamic memory, such as main memory of such a computer platform or other processor controlled device. Tangible transmission media include coaxial cables; copper wire and fiber optics, including the wires that comprise a bus within a computer system or the like. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer or other machine can read programming code and/or data. Many of these forms of computer readable media may be involved in carrying one or more sequences of one or more instructions to a processor for execution.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A software configurable lighting device, comprising:
a light source;
a controllable optical modulator coupled to receive and modulate light output from the source;
a memory;
a programmable controller, coupled to control the light source and the optical modulator and coupled to have access to the memory;
executable programming for the controller stored in the memory; and
lighting device configuration information stored in the memory,
wherein execution of the programming by the controller configures the lighting device to perform functions, including functions to:
operate the light source to provide light output from the lighting device; and
operate the modulator to steer and/or shape the light output from the source to distribute the light output from the lighting device to emulate a lighting distribution of a selected one of a plurality of types of luminaire, based on the lighting device configuration information.

2. The software configurable lighting device of claim 1, wherein the controllable optical modulator comprises an electrowetting optic.

3. The software configurable lighting device of claim 2, wherein the electrowetting optic comprises one or more of: an electrowetting lens, an electrowetting prism, or an electrowetting waveform generator.

4. The software configurable lighting device of claim 2, wherein the electrowetting optic further comprises a water layer, an oil layer, and ZrO2 nanoparticles dispersed in the oil layer.

5. The software configurable lighting device of claim 4, wherein the electrowetting optic comprises a ligand coating formed on a plurality of the ZrO2 nanoparticles.

6. The software configurable lighting device of claim 1, wherein the controllable optical modulator comprises a liquid crystal polarization grating (LCPG) beam steering assembly.

7. The software configurable lighting device of claim 6, wherein the LCPG beam steering assembly comprises a liquid crystal half-waveplate and an active switchable polarization grating.

8. The software configurable lighting device of claim 6, wherein the LCPG beam steering assembly comprises a plurality of active switchable liquid crystal half-waveplates and a plurality passive polarization gratings interspersed with the active switchable liquid crystal half-waveplates.

9. The software configurable lighting device of claim 6, wherein the LCPG beam steering assembly comprises:
a first polarization grating optically coupled to the light source and configured to angularly separate light from the light source into light of different first and second polarizations; and
first and second active polarization grating stacks optically coupled to the first polarization grating to respectively receive the light of the first and second polarizations, each of the active polarization grating stacks being configured to selectively steer the respective light of the first and second polarizations in response to a respective beam steering control signal from the programmable controller.

10. The software configurable lighting device of claim 1, wherein the controllable optical modulator is configured to both selectively steer and selectively shape the light output from the source responsive to one or more control signals from the programmable controller.

11. The software configurable lighting device of claim 1, wherein the controllable optical modulator comprises at least one controllable optic selected from the group consisting of:
(a) micro or nano-electro-mechanical systems (MEMS or NEMS) based dynamic optical beam control;
(b) electrochromic gradient based control;
(c) microlens based passive beam control
(d) passive control using segment control (Y-Y area and pixels);
(e) holographic films; and
(f) switchable diffusers and/or gratings based on liquid crystal display (LCD) materials.

12. The software configurable lighting device of claim 1, wherein the light source comprises at least one source selected from the group consisting of:
an incandescent lamp;
a fluorescent lamp;
a halide lamp;
one or more planar light emitting diodes (LEDs) of different colors;
one or more micro LEDs;
one or more micro organic LEDs;
one or more micro LEDs on gallium nitride (GaN) substrates;
one or more micro nanowire or nanorod LEDs;
one or more micro photo pumped quantum dot (QD) LEDs;
one or more micro plasmonic LEDs;
one or more micro laser diodes;
one or more micro resonant-cavity (RC) LEDs;
one or more micro super luminescent Diodes (SLD); and
one or more micro photonic crystal LEDs.

13. A light fixture, comprising:
a light source; and
means for optically, spatially modulating light output from the source to distribute the light output from the light fixture to emulate a lighting distribution of a selected one of a plurality of types of luminaire for a general illumination application of the one type of luminaire.

14. The light fixture of claim 13, wherein the light source comprises a non-imaging light source for general illumination.

15. The light fixture of claim 14, wherein the non-imaging light source comprises a light emitting diode (LED) light engine.

16. The light fixture of claim 14, wherein the non-imaging light source comprises at least one source selected from the group consisting of:
an incandescent lamp;
a fluorescent lamp;
a halide lamp;
one or more planar light emitting diodes (LEDs) of different colors;
one or more micro LEDs;
one or more micro organic LEDs;
one or more micro LEDs on gallium nitride (GaN) substrates;
one or more micro nanowire or nanorod LEDs;
one or more micro photo pumped quantum dot (QD) LEDs;
one or more micro plasmonic LEDs;
one or more micro laser diodes;
one or more micro resonant-cavity (RC) LEDs;
one or more micro super luminescent Diodes (SLD); and
one or more micro photonic crystal LEDs.

17. The light fixture of claim 13, wherein the means for optically, spatially modulating light output from the source comprises a controllable electrowetting optic coupled to optically process the light output from the source.

18. The light fixture of claim 17, wherein the electrowetting optic is a transmissive electrowetting optic.

19. The light fixture of claim 17, wherein the electrowetting optic is a reflective electrowetting optic.

20. The light fixture of claim 13, wherein the means for optically, spatially modulating light output from the source comprises at least one controllable optic selected from the group consisting of:
(a) micro or nano-electro-mechanical systems (MEMS or NEMS) based dynamic optical beam control;
(b) electrochromic gradient based control;
(c) microlens based passive beam control
(d) passive control using segment control (Y-Y area and pixels);
(e) holographic films; and
switchable diffusers and/or gratings based on liquid crystal display (LCD) materials.

21. A lighting device comprising at least one of the light fixture of claim 13 and a programmable controller coupled to control the means for modulating of each light fixture.

22. An artificial lighting luminaire, comprising:
a light source configured to provide artificially generated light for a general lighting application; and
a controllable electrowetting optic coupled to selectively, optically process the light output from the light source.

23. The luminaire of claim 22, wherein the electrowetting optic is a transmissive electrowetting optic.

24. The luminaire of claim 23, wherein the transmissive electrowetting optic comprises one or more of: an electrowetting lens, an electrowetting prism, or an electrowetting waveform generator.

25. The luminaire of claim 22, wherein the electrowetting optic comprises a water layer, an oil layer, and ZrO2 nanoparticles dispersed in the oil layer.

26. The luminaire of claim 25, wherein the electrowetting optic further comprises a ligand coating formed on a plurality of the ZrO2 nanoparticles.

27. The luminaire of claim 22, wherein the electrowetting optic is a reflective electrowetting optic.

28. The luminaire of claim 27, wherein the reflective electrowetting optic comprises an electrowetting waveform generator.

29. An artificial lighting luminaire, comprising:
a light source configured to provide artificially generated light for a general lighting application; and
a controllable liquid crystal polarization grating (LCPG) beam steering assembly.

30. The luminaire of claim 29, wherein the LCPG beam steering assembly comprises a liquid crystal half-waveplate and an active switchable polarization grating.

31. The luminaire of claim 30, wherein the LCPG beam steering assembly comprises a plurality of active switchable liquid crystal half-waveplates and a plurality passive polarization gratings interspersed with the active switchable liquid crystal half-waveplates.

32. The luminaire of claim 30, wherein the LCPG beam steering assembly comprises:
a first polarization grating optically coupled to the light source and configured to angularly separate light from the light source into light of different first and second polarizations; and
first and second active polarization grating stacks optically coupled to the first polarization grating to respectively receive the light of the first and second polarizations, each of the active polarization grating stacks being configured to selectively steer the respective light of the first and second polarizations in response to a respective beam steering control signal.
